(19) United States
(12) Patent Application Publication
(10) Pub. No.: US 2008/0138727 A1
(43) Pub. Date: Jun. 12, 2008

(54) ELECTROPHOTOGRAPHIC PHOTORECEPTOR AND IMAGE FORMING APPARATUS INCLUDING THE SAME

(76) Inventors: Kotaro FUKUSHIMA, Kawanishi-shi (JP); Tomoko Kanazawa, Kashihara-shi (JP); Tomomi Nakamura, Sakai-shi (JP)

Correspondence Address: NIXON & VANDERHYE, PC, 901 NORTH GLEBE ROAD, 11TH FLOOR, ARLINGTON, VA, 22203, US

(21) Appl. No.: 11/950,865

(22) Filed: Dec. 5, 2007

(30) Foreign Application Priority Data
Dec. 6, 2006 (JP) 2006-329448
Jan. 17, 2007 (JP) 2007-008144

(51) Int. Cl. G03G 15/02; G03G 15/00

(52) U.S. Cl. 430/58.35; 399/159; 430/58.05

(57) ABSTRACT

It is an object of the present invention to provide a highly durable electrophotographic photoreceptor which is superior in mechanical and electrical durability and does not cause abnormal images to occur for prolonged repeated use, and an image forming apparatus including the same. An electrophotographic photoreceptor comprising at least a charge generation layer and a charge transport layer in this order on a conductive substrate, wherein the outermost surface layer of the electrophotographic photoreceptor contains filler particles and the filler particles in the layer satisfy the following equation (I):

1.0×10⁻³≦(df×b³)/(dm×a³)≦2.5×10⁻² , (I)

wherein “a” is an average filler interparticle distance (nm), “b” is an average diameter (nm) of filler particles, “df” is a density (g/cm³) of the filler particles, and “dm” is an average density (g/cm³) of a solid in the outermost surface layer is provided.

### CROSS-REFERENCE TO RELATED APPLICATION

This application is related to Japanese Patent Application No. 2006-329448 filed on 6 Dec. 2006 and No. 2007-8144 filed on 17 Jan. 2007, whose priorities are claimed under 35 USC §119, the disclosure of which is incorporated by reference in its entirety.

### BACKGROUND OF THE INVENTION

1. Field of the Invention

The present invention relates to an electrophotographic photoreceptor used for forming electrophotographic images and an image forming apparatus including the same.

2. Description of the Related Art

In electrophotographic image forming apparatuses (hereinafter, also referred to as an electrophotographic apparatus) used as copying machines, printers or facsimiles, an image is formed through the following electrophotographic process.

First, a photosensitive layer of an electrophotographic photoreceptor (hereinafter, just referred to as a photoreceptor) included in the apparatus is charged evenly to a prescribed potential with a charger.

Next, the photoreceptor is exposed by light such as laser light irradiated in accordance with image information from an exposure unit to form an electrostatic latent image.

A developer is supplied from a development unit to the formed electrostatic latent image, and the electrostatic latent image is developed to form a clear image as a toner image by depositing colored fine particles called a toner, which is a component of the developer, on a surface of the photoreceptor.

The formed toner image is transferred from the photoreceptor surface onto a transfer material such as recording paper by transfer means and fused by a fusing unit.

However, all of the toner on the surface of the photoreceptor is not transferred to recording paper to be shifted in a transfer operation by the transfer means, and a part of the toner remains on the photoreceptor surface. Further, paper powder of the recording paper coming into contact with the photoreceptor during transfer can remain on the surface of the photoreceptor without being removed. Since such foreign substances, such as a residual toner and deposited paper powder, on the surface of the photoreceptor have an adverse effect on quality of images to be formed, they are removed by a cleaning device.

In recent years, cleaner-less technology progresses, and there is also a method in which the so-called development-cum-cleaning system, which recovers the residual toner with a cleaning function added to a development unit without having a separate cleaning unit, removes the above-mentioned foreign substances. In this method, after cleaning the photoreceptor surface, the surface of the photosensitive layer is diselectrified with a diselectrifying device to erase the electrostatic latent image.

An electrophotographic photoreceptor used in such an electrophotographic process has a constitution in which a photosensitive layer containing photoconductive materials is laminated on a conductive substrate made of conductive materials.

As an electrophotographic photoreceptor, hitherto, electrophotographic photoreceptors using inorganic photoconductive materials (hereinafter, referred to as an inorganic photoreceptor) have been used.

Typical examples of the inorganic photoreceptor include selenium photoreceptors using a layer made of amorphous selenium (a-Se), amorphous arsenic-selenium (a-AsSe), or the like as a photosensitive layer, zinc oxide photoreceptors or cadmium sulfide photoreceptors using, as a photosensitive layer, a resin in which zinc oxide (ZnO) or cadmium sulfide (CdS) is dispersed together with a sensitizing agent such as dye, and amorphous silicon photoreceptors (hereinafter, referred to as an a-Si photoreceptor) using a layer made of amorphous silicon (a-Si) as a photosensitive layer.

However, the inorganic photoreceptor has the following defects.

That is, the selenium photoreceptor and the cadmium sulfide photoreceptor have problems of heat resistance and storage stability. Further, since selenium and cadmium have toxicity to human bodies and environments, photoreceptors using these have to be recovered after use and to be adequately disposed of.

On the other hand, the zinc oxide photoreceptor has a disadvantage that sensitivity is low and durability is also low, and it is little used at present.

Further, the a-Si photoreceptor attracting attention as a nonpolluting inorganic photoreceptor has advantages of high sensitivity and high durability, but this photoreceptor has disadvantages that it is difficult to form a uniform photosensitive layer and defective images are apt to occur since it is produced by use of a plasma chemical vapor deposition process. Furthermore, the a-Si photoreceptor also has disadvantages that productivity is low and production cost is high.

Since the inorganic photoreceptor has many defects as described above, the development of a photoconductive material used for the electrophotographic photoreceptor is progressed, the organic photoconductive material, that is, an organic photoconductor (abbreviation:OPC) is increasingly employed in place of the heretofore used inorganic photoconductive material.

The electrophotographic photoreceptor (hereinafter, referred to as an organic photoreceptor) using the organic photoconductive material has a problem a little in sensitivity, durability and stability against environments. However, it has many advantages in point of toxicity, production cost and flexibility of material design compared with the inorganic photoreceptor.

The organic photoreceptor also has an advantage that the photosensitive layer can be formed by an easy and low-cost method typified by a dip coating method.

The organic photoreceptor increasingly becomes mainstream of the electrophotographic photoreceptor since it has many advantages as described above.

Further, by research and development in recent years, the sensitivity and the durability of the organic photoreceptor are improved, and the organic photoreceptor is currently used as an electrophotographic photoreceptor except for the special cases.

In particularly, a performance of the organic photoreceptor is significantly improved by the development of a layered photoreceptor in which separate substances play a charge generation function and a charge transport function, respectively.

That is, the layered photoreceptor also has an advantage that the scope of the selection of materials composing the photosensitive layer is wide and a photoreceptor having any characteristic can be produced with relative ease in addition to the advantages which organic photoreceptors have.

The layered photoreceptor includes two types of a layered type and a single layer type.

In the layered photoreceptor of the above-mentioned layered type, a layered type photosensitive layer, which is constituted by layering the charge generation layer containing a charge generation substance playing the charge generation function and the charge transport layer containing a charge transport substance playing the charge transport function, is provided.

The charge generation layer and the charge transport layer are generally formed in a form of being respectively dispersed in a binding resin being a binder.

On the other hand, in a function distribution photoreceptor of the single layer type, a single layer type photosensitive layer in which the charge generation substance and the charge transport substance are dispersed together in the binding resin is provided.

Further, in the electrophotographic apparatus, operations of charging, exposure, development, transfer, cleaning and diselectrifying are repeatedly performed for the photoreceptors under various environments. Therefore, it is required that the photoreceptor is superior in environmental stability, electrical stability and durability against a mechanical external force (printing durability) in addition to high sensitivity and high optical response.

That is, high printing durability, by which a surface layer of the photoreceptor hardly wear from rubbing against cleaning members, is required.

As an efforts to improve the printing durability, a method of placing a protective layer on the outermost surface layer of the photoreceptor (for example, Japanese Unexamined Patent Publication No. 57-30346), a method of imparting lubricity to the protective layer (for example, Japanese Unexamined Patent Publication No. 1(64)-23259), a method of curing the protective layer (for example, Japanese Unexamined Patent Publication No. 61-72256), and a method of including filler particles in the protective layer (for example, Japanese Unexamined Patent Publication No. 1-172970) are known.

Furthermore, it is proposed that a layer formed by dispersing metal oxide including tin oxide, or tin oxide and antimony oxide or one containing both in a thermosetting resin (heat curable polyurethane) is constructed in the outermost surface layer as a surface layer of the sensitivity (for example, Japanese Unexamined Patent Publication No. 8-234469). Further, it is also proposed that a layer formed by dispersing the conductive fine particles such as zinc oxide, titanium oxide, tin oxide, antimony oxide, indium oxide, bismuth oxide and tin-doped indium oxide is constructed in the outermost surface layer (for example, Japanese Unexamined Patent Publication No. 6-35220).

It is basically desired that these protective layers are thinned as far as possible from a viewpoint of not impairing the fundamental performance of the photosensitive layer.

However, by providing this protective layer, the following various adverse effects arise.

For example, in the case of a layered structure in which an interface is formed between the photoreceptor and the surface protective layer and components between the photoreceptor and the surface protective layer are separated, the protective layer may be peeled off by prolonged use. Furthermore, by prolonged repeated use, a potential of the exposure section can increase.

Inversely, when the surface protective layer and the photosensitive layer form a continuous layer, that is, when the photosensitive layer is dissolved in a surface protective layer coating solution for forming a surface protective layer, image characteristics may be deteriorated depending on a dissolved state.

Among others, an addition system of the filler particles will add new factors having effects on characteristics of controlling the dispersibility of the particle. That is, the characteristics are not specified just by an addition amount of the filler particles. It is disclosed that addition of the filler particles up to the extent of about 0.1% to 10% with respect to the total solid content of the surface protective layer is effective for improvement in the printing durability (for example, Japanese Unexamined Patent Publication No. 1-20517). However, in this case, it is not clear at present whether the difference in the dispersion conditions has an effect on image characteristics/electrical characteristics/printing durability of a photoreceptor drum or not. Irregularities in the dielectric constant of the surface protective layer may cause image growth of edge area and toner scattering in outputting black solid images, or dispersion conditions within the surface layer can have a large effect.

As the adverse effects of improving the printing durability, image blurring and image deletion due to influence of charged products adhering to the surface of a drum occur particularly in environments of high temperature and high humidity. In order to preclude these adverse effects, a unit, in which the photoreceptor is designed to be able to be chafed to some extent, or a uniform and inactive drum surface is provided by contriving the cleaning unit, is disclosed. (for example, Japanese Unexamined Patent Publication No. 2004-61560).

In the function distribution photoreceptor, if an effect of the printing durability can be imparted to the outermost surface, a redundant step in a production process becomes unnecessary, and therefore there is a large economical merit compared with the case of providing the protective layer. Further, it also becomes possible to avoid the above-mentioned adverse effects produced by laminating the photosensitive layer and the protective layer.

However, on the other hand, it becomes necessary to consider new problems in the system. For example, in adding the filler particles for improving the printing durability, an interface between a phase of the filler particles and a surrounding resin-based phase, which are different from each other, may act as an electrical trap. When the filler particles are added to the whole charge transport layer (generally, a film thickness is 10 to 50 μm), if a concentration of the particle in the layer is constant, increase in residual potential resulting from the abovementioned trap becomes remarkable in comparison with the case where the filler particles are added to only the outermost layer (generally about several microns or less) to form the above interface between different phases.

In the case of the layered photoreceptor, defects may occur because of ununiformity of a layer produced in a vicinity of an interface between the charge generation layer and the charge transport layer probably due to an interaction between the filler particles and the charge generation layer.

Further, as another conventional method, there is a method of improving printing durability by reducing a coefficient of friction of the surface layer of the photoreceptor. As a method of reducing the coefficient of friction, a method in which a lubricant is applied to an image support with a brush or a roller is proposed (for example, Japanese Unexamined Patent Publication No. 8-202226, Japanese Unexamined Patent Publication No. 9-251263).

Examples of the lubricant include zinc stearate, or silicone base or fluorine base lubricant.

However, if a lubricant is supplied to the whole area of the photoreceptor in an amount considered as adequate in order to satisfy the printing durability, or if the coefficient of friction of the surface of the photoreceptor is reduced more than necessary, this has an adverse effect that development ability of the photoreceptor surface is deteriorated, that is, decrease in the image density occurs, or image deletion occurs.

Therefore, an image forming apparatus including a photoreceptor which satisfies printing durability and has electrical properties such as sensitivity sufficient for high durability, and maintaining image quality without filming and image deletion for a long time.

### SUMMARY OF THE INVENTION

It is an object of the present invention to provide a highly durable electrophotographic photoreceptor which is superior in mechanical and electrical durability and does not cause abnormal images to occur for prolonged repeated use, and an image forming apparatus including the same.

The present inventors made earnest efforts, and consequently they have succeeded in development of a highly durable electrophotographic photoreceptor which is superior in mechanical and electrical durability and does not cause abnormal images to occur for prolonged repeated use by containing filler particles in an outermost surface layer of a photosensitive layer composing the photoreceptor in contrast to a layered electrophotographic photoreceptor produced so as to have a constitution of conventional art, to complete the present invention.

Therefore, in accordance with the present invention, an electrophotographic photoreceptor including at least a charge generation layer and a charge transport layer in this order on a conductive substrate, wherein the outermost surface layer of the electrophotographic photoreceptor contains filler particles and the filler particles in the layer satisfy the following equation (I):

1.0×10⁻³≦(df×b³)/(dm×a³)≦2.5×10⁻² (I),

wherein “a” is an average filler interparticle distance (nm), “b” is an average diameter (nm) of filler particles, “df” is a density (g/cm³) of the filer particles, and “dm” is an average density (g/cm³) of a solid in the outermost surface layer is provided.

By employing a constitution of the present invention, it is possible to provide a stable electrophotographic photoreceptor which is superior in printing durability, and retains electrical stability and does not cause deterioration of images to occur for prolonged repeated use, and an image forming apparatus including this electrophotographic photoreceptor.

That is, in accordance with the present invention, since it becomes possible that the charge transport layer of the photoreceptor increases largely in printing durability, a range of options such as a charge transport substance, a ratio of binding resin, and other additives for properly setting performance including sensitivity other than printing durability is broadened. Therefore, by properly selecting the charge transport substance, the ratio of binding resin, and other additives, it is possible to produce a more excellent photoreceptor which can reduce an abrasion rate and can attain images of high quality without decreasing sensitivity in a prolonged use.

Further, an image forming apparatus including such a photoreceptor can maintain the images of high quality for a long time since the photoreceptor has adequate printing durability and durability and works stably for a long time. Therefore, cost reduction and maintenance-free of the image forming apparatus can be realized.

### BRIEF DESCRIPTION OF THE DRAWINGS

FIG. 1 is a partial sectional view showing schematically a constitution of an electrophotographic photoreceptor 1 of a first embodiment of the present invention,

FIG. 2 shows a difference in diameter of agglomerates depending on dispersion conditions of filler particles of an embodiment of the present invention,

FIG. 3 is a partial sectional view showing schematically a constitution of an electrophotographic photoreceptor 2 of a second embodiment of the present invention,

FIG. 4 is a layout side view showing schematically a constitution of an image forming apparatus 30 of a third embodiment of the present invention, and

FIG. 5 is a layout side view showing schematically a constitution of an image forming apparatus of a fourth embodiment of the present invention.

### DETAILED DESCRIPTION OF THE INVENTION

Hereinafter, the present invention will be described in detail.

### First Embodiment

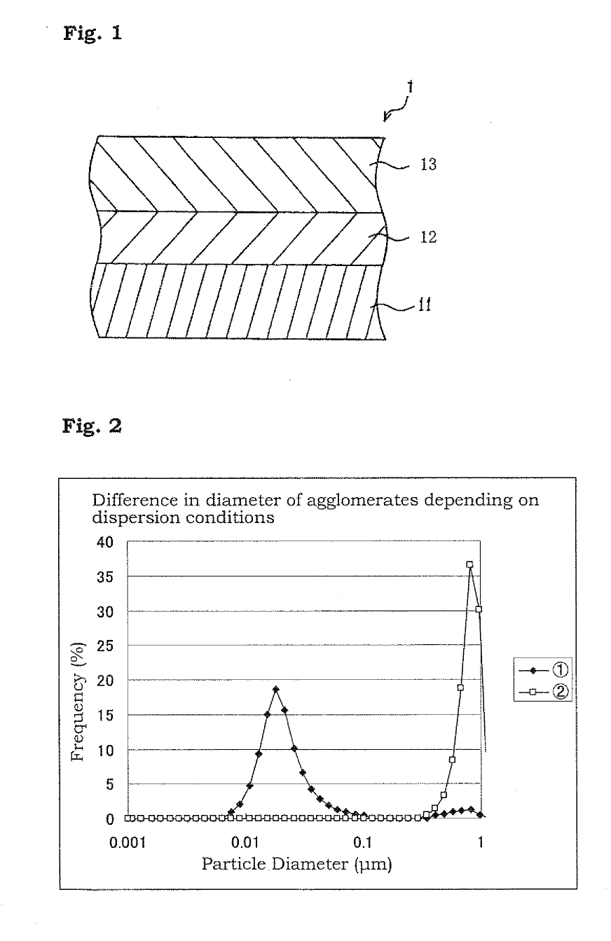

FIG. 1 is a partial sectional view showing schematically a constitution of an electrophotographic photoreceptor 1 of a first embodiment of the present invention. The electrophotographic photoreceptor 1 (hereinafter, abbreviated to a photoreceptor) of the first embodiment includes a cylindrical conductive substrate 11 made of a conductive material, a charge generation layer 12 which is a layer laminated on a peripheral surface of the conductive substrate 11 and contains a charge generation substance, and a charge transport layer 13 which is a layer further laminated on the charge generation layer 12 and contains a charge transport substance. The charge generation layer 12 and the charge transport layer 13 constitute a photosensitive layer 14. That is, the photoreceptor 1 is a layered photoreceptor.

### (Conductive Substrate)

The conductive substrate 11 serves as an electrode of the photoreceptor 1 and also serves as a supporting member of other layers 12 and 13.

A shape of the conductive substrate 11 is a cylindrical shape in the first embodiment, but it is not limited to this and may be the shape of a circular cylinder, a sheet, or an endless belt.

As the conductive material composing the conductive substrate 11, for example, a conductive metal or alloy material such as aluminum, copper, brass, zinc, nickel, stainless steel, chromium, molybdenum, vanadium, indium, titanium, gold or platinum; or conductive metal, alloy or metal oxide such as aluminum, aluminum alloy, tin oxide, gold or indium oxide can be used.

Further, without being limited to these metal materials, substances, which are formed by laminating a foil of the above-mentioned metal, depositing the above-mentioned metal material by vapor deposition, or depositing by vapor deposition or applying a layer of a conductive compound such as a conductive polymer, tin oxide, or indium oxide on a surface of a polymer material such as polyethylene terephthalate, nylon, polyester, polyoxymethylene or polystyrene, hardened paper, glass or the like, can also be employed.

These conductive materials are processed into a prescribed shape and used.

An anodic oxide film treatment, a surface treatment with chemicals, hot water, or the like, a coloring treatment or a diffuse reflection treatment for roughening a surface may be applied to the surface of the conductive substrate 11 within the limits of not affecting image quality as required.

In an electrophotographic process in which laser is used as an exposure source, since wavelengths of laser light are identical, there may be cases where interference occurs between laser light reflected off the photoreceptor surface and laser light reflected from within the photoreceptor, and interference fringes due to this interference appear on the image to cause image defects.

However, image defects due to the interference of the laser light having identical wavelengths can be prevented by applying the above-mentioned treatment to the surface of the conductive substrate 11.

### (Charge Generation Layer)

The charge generation layer 12 contains a charge generation substance to generate charges through light absorption as a principal component.

Examples of substances functioning effectively as the above-mentioned charge generation substance include organic photoconductive materials including organic pigments and inorganic photoconductive materials including inorganic pigments.

Examples of the above-mentioned organic photoconductive materials including organic pigments include azo pigments such as monoazo pigments, bisazo pigments, trisazo pigments and the like, indigo pigments such as indigo, and thioindigo, perylene pigments such as peryleneimide, and perylene acid anhydride, polycyclic quinone pigments such as anthraquinone, and pyrenequinone, phthalocyanine pigments such as metal phthalocyanine, and non-metal phthalocyanine, squarylium dye, pyrylium salts and thiopyrylium salts, and triphenylmethane dyes.

Further, examples of the above-mentioned inorganic photoconductive materials including inorganic pigments include selenium and alloys thereof arsenic-selenium, cadmium sulfide, zinc oxide, amorphous silicon, and other inorganic photoconductors.

The above-mentioned charge generation substances may be used singly, or may be used in combination of two or more species.

Among the above-mentioned charge generation substances, it is preferable to use an oxotitanium phthalocyanine compound expressed by the following structural formula (A):

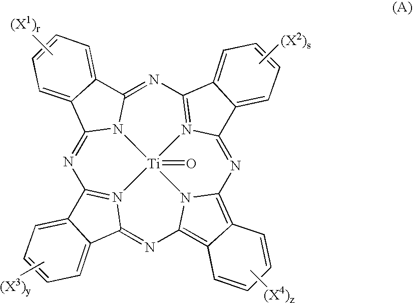

wherein X¹, X², X³ and X⁴ each represent a halogen atom, an alkyl group or an alkoxy group, and r, s, y and z are each an integer of 0 to 4.

Examples of the halogen atoms, which X¹, X², X³ and X⁴ in the above-mentioned structural formula (A) represent, include a fluorine, a chlorine, a bromine and an iodine atom.

Further, examples of the alkyl groups, which the above-mentioned X¹, X², X³ and X⁴ represent, include C₁-C₄ alkyl groups such as a methyl, an ethyl, a propyl, an isopropyl, a butyl, an isobutyl and a t-butyl groups.

Further, examples of the alkoxy groups, which the X¹, X², X³ and X⁴ represent, include C₁-C₄ alkoxy groups such as a methoxy, an ethoxy, a propoxy, an isopropoxy, a butoxy, an isobutoxy and a t-butoxy groups.

Since the oxotitanium phthalocyanine compound expressed by the structural formula (A) is a charge generation substance having high charge generation efficiency and high charge injection efficiency, large amounts of charge is generated through light absorption by using this compound for the charge generation layer 125 and the generated charge can be efficiently injected into the charge transport substance contained in the charge transport layer 13 without being accumulated within the charge generation layer, and smoothly transported to the surface of the photosensitive layer 14.

The oxotitanium phthalocyanine compound expressed by the structural formula (A) can be produced by publicly known production methods such as a method described in Moser, Frank H, Arthur L. Thomas, “Phthalocyanine Compounds”, Reinhold Publishing Corp., New York, 1963.

For example, of the oxotitanium phthalocyanine compounds expressed by the structural formula (A), unsubstituted oxotitanium phthalocyanine in which r, s, y and z are 0 can be obtained by synthesizing dichlorotitanium phthalocyanine by heat melting of phthalonitrile and titanium tetrachloride or by heat reaction of them in an appropriate solvent such as α-chloronaphthalene, and then hydrolyzing dichlorotitanium phthalocyanine with a base or water.

The oxotitanium phthalocyanine can also be produced by heat reaction of isoindoline and titanium tetraalkoxide such as tetrabutoxytitanium in an appropriate solvent such as N-methylpyrrolidone.

The charge generation substance may be used in combination with a sensitizing dye such as triphenylmethane dyes typified by methyl violet, crystal violet, night blue and victoria blue, acridine dyes typified by Erythrocin, rhodamine B, rhodamine 3R, acridine orange and frapeosine, thiazine dyes typified by methylene blue and methylene green, oxazine dyes typified by capri blue and meldola blue, cyanine dyes, styryl dyes, pyrylium salt dyes, or thiopyrylium salt dyes.

As a method of forming the charge generation layer 12, a method of depositing the above-mentioned charge generation substance on the surface of the conductive substrate 11 by vacuum deposition, or a method of applying a coating solution for a charge generation layer obtained by dispersing the charge generation substance in an appropriate solvent onto the surface of the conductive substrate 11 are employed.

Among these method, a method, in which the charge generation substance is dispersed, by a publicly known method, in a binding resin solution obtained by mixing a binding resin being a binder in a solvent to prepare a coating solution for a charge generation layer and the resulting coating solution is applied onto the surface of the conductive substrate 11, is suitably used. Hereinafter, this method will be described.

Examples of the binding resin used in the charge generation layer 12 include resins such as a polyester resin, a polystyrene resin, a polyurethane resin, a phenolic resin, an alkyd resin, a melamine resin, an epoxy resin, a silicone resin, an acrylic resin, a methacrylic resin, a polycarbonate resin, a polyallylate resin, a phenoxy resin, a polyvinyl butyral resin, a polyvinyl chloride resin and a polyvinylformal resin, and copolymer resins containing two or more of repeat units composing these resins.

Specific examples of the copolymer resins include insulating resins such as a vinyl chloride-vinyl acetate copolymer resin, a vinyl chloride-vinyl acetate-maleic anhydride copolymer resin and an acrylonitrile-styrene copolymer resin.

The binding resin is not limited to these resins, and resins commonly used can be used as a binding resin. These resins may be used singly, or may be used as a mixture of two or more species.

For the solvent of the coating solution for a charge generation layer, halogenated hydrocarbon such as dichloromethane or dichloroethane, alcohol such as methanol or ethanol, ketone such as acetone, methyl ethyl ketone or cyclohexanone, ester such as ethyl acetate or butyl acetate, ether such as tetrahydrofuran or dioxane, alkyl ether of ethylene glycol such as 1,2-dimethoxyethane, aromatic hydrocarbon such as benzene, toluene or xylene, or an aprotic polar solvent such as N,N-dimethylformamide or N,N-dimethylacetoamide is used.

Among the above-mentioned solvents, non-halogen organic solvents are suitably used in consideration of earth's environment The above-mentioned solvent may be used singly, or may be used as a mixed solvent of two or more species.

In the charge generation layer 12 having a constitution including the charge generation substance and the binding resin, a ratio W1/W2 of a weight W1 of the charge generation substance to a weight W2 of the binding resin is preferably 10/100 or more and 400/100 or less.

When the ratio W1/W2 is less than 10/100, the sensitivity of the photoreceptor 1 is reduced.

Inversely, when the ratio W1/W2 is more than 400/100, since not only film strength of the charge generation layer 12 is deteriorated but also the dispersibility of the charge generation substance is deteriorated to increase the number of coarse particles, surface charges other than those in an area to be erased by exposure are deceased, and therefore image defects, particularly the fog of image referred to as a black spot, in which a toner adheres to a white background to form minute black points, increases.

Therefore, as a favorable range of the ratio W1/W2, a range of 10/100 or more and 400/100 or less is selected.

The charge generation substance may be previously ground with a mill before it is dispersed in the binding resin solution.

Examples of the mills to be used for a grinding treatment include a ball mill, a sand mill, an Attritor, a vibrating mill and an ultrasonic dispersion machine.

Examples of a dispersion machine to be used in dispersing the charge generation substance in the binding resin solution include a paint shaker, a ball mill and a sand mill. As a dispersion condition in this time, appropriate conditions, in which impurities due to abrasion of members constituting a container and a dispersion machine to be used are not immixed, are selected.

Examples of a method of applying the coating solution for a charge generation layer include a spray coating method, a bar coating method, a roller coating method, a blade coating method, a ring coating method and a dip coating method.

An optimal method can be selected from these coating methods in consideration of the physical properties and the productivity of the coating solution.

Among these application methods, particularly, the dip coating method is a method of forming a layer on the surface of a substrate by immersing the substrate in a coating bath filled with a coating solution and pulling up the substrate at a constant speed or successively varying speed, and it is relatively simple and superior in productivity and cost, and therefore it is often used in producing the electrophotographic photoreceptor. Further, a device for dispersing a coating solution typified by an ultrasonic generation unit may be provided for a device to be used for the dip coating method in order to stabilize the dispersibility of the coating solution.

A film thickness of the charge generation layer 12 is preferably 0.05 μm or more and 5 μm or less, and more preferably 0.1 μm or more and 1 μm or less.

When the film thickness of the charge generation layer 12 is less than 0.05 μm, the efficiency of light absorption is lowered and the sensitivity of the photoreceptor 1 is reduced.

Inversely, when the film thickness of the charge generation layer 12 is more than 5 μm, charge transfer within the charge generation layer 12 becomes a rate-determining step of a process of erasing the surface charge of the photosensitive layer 14, and the sensitivity of the photoreceptor 1 is reduced.

Therefore, as a favorable range of the film thickness of the charge generation layer 12, a range of 0.05 μm or more and 5 μm or less is selected.

### [Charge Transport Layer]

The charge transport layer 13 is provided on the charge generation layer 12. The charge transport layer 13 can have a constitution including the charge transport substance having an ability to receive charges which the charge generation substance contained in the charge generation layer 12 generates and to transport these charges, the binding resin to bind the charge transport substance, and further the filler particles to improve the durability of the photoreceptor.

Examples of the above-mentioned charge transport substance include enamine derivatives, carbazole derivatives, oxazole derivatives, oxadiazole derivatives, thiazole derivatives, thiadiazole derivatives, triazole derivatives, imidazole derivatives, imidazolone derivatives, imidazolidine derivatives, bisimidazolidine derivatives, styryl compounds, hydrazone compounds, polycyclic aromatic compounds, indole derivatives, pyrazoline derivatives, oxazolone derivatives, benzimidazole derivatives, quinazoline derivatives, benzofuran derivatives, acridine derivatives, phenazine derivatives, aminostilbene derivatives, triarylamine derivatives, triarylmethane derivatives, phenylenediamine derivatives, stilbene derivatives and benzidine derivatives.

In addition, a polymer having a group produced from these compounds on a main chain or a side chain, for example, poly(N-vinylcarbazole), poly(1-vinylpyrene), poly-γ-carbazolyl ethylglutamate, polyvinylpyrene, polyvinylphenanthrene and poly(9-vinylanthracene) are also exemplified.

Furthermore, the present inventors have found that by using an aromatic amine compound having a butadiene group, which has resistance to gases such as O₃ and NOx generated in an electrophotographic process, as a charge transport substance, it becomes possible to form a stable photoreceptor which does not cause the deterioration of images after repeated use.

That is, in accordance with the present invention, an electrophotographic photoreceptor, wherein the charge transport layer contains, as a charge transport substance, an amine compound expressed by the following structural formula (1);

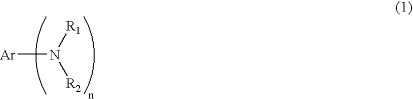

in which R₁ and R₂ may be identical to or different from each other, and represent an alkyl group having 1 to 4 carbon atoms, or R₁ and R₂ may be combined with each other to form a heterocyclic group containing a nitrogen atom, n represents an integer of 1 to 4, and Ar represents an aromatic ring group having a substituted butadienyl group, is provided.

More specifically, an electrophotographic photoreceptor containing an aromatic amine compound having an aromatic compound-substituted butadienyl group as a charge transport substance is provided.

For the binding resin composing the charge transport layer 13, resins having polycarbonate which is well known in this art as the principal component are suitably selected because of excellent transparency and printing durability.

In addition to this, examples of a second component of this binding resin include vinyl polymer resins such as a polymethyl methacrylate resin, a polystyrene resin and a polyvinyl chloride resin, and copolymer resins containing two or more of repeat units composing these resins, and a polyester resin, a polyestercarbonate resin, a polysulfone resin, a phenoxy resin, an epoxy resin, a silicone resin, a polyallylate resin, a polyamide resin, a polyether resin, a polyurethane resin, a polyacrylamide resin, and a phenolic resin. In addition, thermosetting resins formed by partially crosslinking these resins are also exemplified. These resins may be used singly, or may be used as a mixture of two or more species.

In addition, the above-mentioned principal component means that are weight percentage of polycarbonate resin makes up the largest percentage of the total binding resins composing the charge transport layer, and more preferably means that the weight percentage of polycarbonate resin makes up 50 to 90% by weight.

Further, a resin as the above-mentioned second component is used in an amount within a range of 10 to 50% by weight of the above total binding resins.

Further, a ratio between the charge transport substance and the binding resin in the charge transport layer is preferably in a range of 10/10 to 10/18 by weight.

The filler particles composing the charge transport layer 13 are broadly divided into organic filler particles and inorganic filler particles centering on metal oxide.

In general, the organic filler particles centering on fluorine base materials are used for controlling a wetting property of the surface of the photoreceptor and inhibiting attaching of foreign substances. On the other hand, the inorganic filler particles are mainly used for applications aimed at improving printing durability.

In the present invention, the photoreceptor is formed by use of the latter, namely the inorganic filler particles.

As for characteristics of the inorganic filler particles, filler particles which have high hardness as a material and are readily dispersed in the binding resin is favorable, and example of the inorganic filler particles include particles of oxides such as silicon oxide (silica), titanium oxide, zinc oxide, calcium oxide and aluminum oxide (alumina), and particles of nitride compounds such as silicon nitride and aluminum nitride.

Further, when the above-mentioned filler particles are added to the photoreceptor, the photoreceptor exhibits good printing durability not by a mere addition amount of the filler particles but in a range specified by the following equation (I):

1.0×10⁻³≦(df×b³)/(dm×a³)≦2.5×10⁻² (I)

wherein “a” is an average filler interparticle distance (nm), “b” is an average diameter (nm) of filler particles, “df” is a density (g/cm³) of the filler particles, and “dm” is an average density (g/cm³) of a solid in the outermost surface layer, which takes a particle diameter and a dispersion state of the filler particles into account.

In the above-mentioned equation (I), it is assumed that the filler particles are true-sphere and is evenly distributed in a homogeneous solid medium and this particle is close-packed in the above-mentioned medium.

In addition, the solid medium in the outermost surface layer of the above-mentioned photoreceptor refers to the binding resin and the charge transport substance, composing the charge transport layer, and a substance evenly distributed is the filler particles.

Incidentally, a density “df” of the filler particles in the outermost surface layer of the photoreceptor can be measured according to JIS 7112.

Further, an average density “dm” of the solid matter in the outermost surface layer can be determined by calculation based on mixing ratios and densities of constituent solid matter.

That is, if the addition amount, the particle diameter and the density of the filler particles, and the density of the medium (properly speaking, the density of the overall solid matter including the filler particles) are determined, “a”: an average filler interparticle distance is determined, and it becomes possible to judge by substituting these values into the equation (I).

In other words, since this relational expression is built on premises that the filler particles are evenly “packed”, the contents of claims of the present invention are only satisfied if the dispersion in a coating solution/a coat is uniform and the addition amount of the filler particles corresponding to the equation (I) is defined.

Further, the average filler interparticle distance a can also be determined based on, for example, microscopic observations (for example, TEM and/or SEM and/or atomic force observation) of the surface and/or a cross section of the charge transport layer.

For species of the inorganic filler particles, in consideration of light scattering in a system, it became clear that silicon oxide (silica) having a small difference from the medium in a refractive index is suitable, and the filler particles having a small particle diameter are preferable in order to minimize the light scattering and adverse effect on an electrical carrier in the system.

Specifically, as the filler particles, silica having a particle diameter of 100 nm or less is suitable, and silica having an average particle diameter of preferably 70 to 0.1 nm, further preferably 40 to 1 nm, and more preferably 30 to 5 nm is preferable.

In adding the filler particles, various dispersing unit, such as a ball mill, a sand mill, an Attritor, a vibrating mill, an ultrasonic dispersion machine and a paint shaker, which are publicly known to those skilled in the art can be used in order to form a state of uniform particle dispersion.

Further, it is an essential item to grasp a dispersion state of the filler in a dispersion for forming a coat on the outermost surface of the electrophotographic photoreceptor or after the formation of the coat in order to bring out excellent properties of the electrophotographic photoreceptor.

### (Dispersion Method)

Two kinds of dispersion is performing by the same coating solution prescription, and a particle size distribution in a coating solution subjected to one dispersion treatment was compared with that in a coating solution subjected to the other dispersion treatment. The results of the comparison are shown in FIG. 2. 1.55 g of a polycarbonate resin GH-503 ((trade name), produced by Idemitsu Kosan Co., Ltd.), 1.55 g of a polycarbonate resin TS 2040 ((trade name), produced by Teijin Chemicals Ltd.) and 3.1 g of silica (TS-610 (trade name), average particle diameter: 17 nm, produced by Cabot Specialty Chemicals Inc.) were mixed in 55.9 g of tetrahydrofuran, and the resulting mixture was dispersed for 5 hours with a ball mill to prepare a primarily dispersed coating solution for a charge transport layer, and a particle size distribution of the resulting coating solution was measure (using UPA-150 (manufactured by NIKKISO Co., Ltd.)). The results of measurement of the particle size distribution are shown in FIG. 2 (1).

It is evident from these results that in the above-mentioned method, the filler particles in the coating solution are stably dispersed to a primary particle diameter.

On the other hand, FIG. 2 (2) shows the results of dispersing the same solution for 5 hours with a paint shaker. It is evident that in this method, silica having an average particle diameter of 17 nm, which is used, forms agglomerates having a particle diameter of micron order.

These changes in an agglomeration state directly correspond to electric properties and surface uniformity of a final coat.

Therefore, the formation of uniform dispersed matter, a particle size of which is close to a primary particle size, in the dispersed solution is reflected on the dispersed matter in a coat, and consequently the outermost surface layer having excellent printing durability is formed.

Here, “dispersed matter, a particle diameter of which is close to a primary particle diameter” refers to dispersed matter in which an agglomerate diameter having the highest occurrence rate (peak agglomerate diameter) is within ten times an average particle diameter of a single particle (primary particle diameter).

Various additives may be added to the charge transport layer 13 as required. That is, a plasticizer or a leveling agent may be added to the charge transport layer 13 in order to improve a film forming property, flexibility, or surface smoothness.

Examples of the above-mentioned plasticizer include dibasic acid esters such as phthalic acid ester, aliphatic acid esters, phosphoric acid esters, chlorinated paraffin and epoxy type plasticizers.

Further, examples of the above-mentioned leveling agent include silicone base leveling agents.

For example, the charge transport substance, the binding resin, the filler particles, and the additive if necessary are dissolved or dispersed in an appropriate solvent to prepare a coating solution for a charge transport layer, and the charge transport layer 13 is formed by applying the resulting coating solution onto the charge generation layer 12 as in the case of forming the charge generation layer 12 by applying the coating solution.

Examples of the solvent of the coating solution for a charge transport layer include aromatic hydrocarbons such as benzene, toluene, xylene and monochlorobenzene, halogenated hydrocarbons such as dichloromethane and dichloroethane, ethers such as tetrahydrofuran, dioxane and dimethoxymethyl ether, and aprotic polar solvent such as N,N-dimethylformamide. These solvents may be used singly, or may be used as a mixture of two or more species.

It is also possible to further add a solvent such as alcohols, acetonitrile or methyl ethyl ketone to the above-mentioned solvents as required and use a mixed solvent. Among these solvents, non-halogen organic solvents are suitably used in consideration of earth's environment.

Examples of a method of applying the coating solution for a charge transport layer include a spray coating method, a bar coating method, a roller coating method, a blade coating method, a ring coating method and a dip coating method. Among these application methods, particularly, the dip coating method is often used in forming the charge transport layer 13 since it is superior in various points as described above.

A film thickness of the charge transport layer 13 is preferably 5 μm or more and 40 μm or less, and more preferably 10 μm or more and 30 μm or less.

When the film thickness of the charge transport layer 13 is less than 5 μm, a charge-retentive ability is lowered. Further, when the film thickness of the charge transport layer 13 is more than 40 μm, the resolution of the photoreceptor 1 is reduced.

Therefore, as a favorable range of the film thickness of the charge transport layer 13, a range of 5 μm or more and 40 μm or less is selected.

To the respective layers of the photosensitive layer 14, one or more of sensitizing agents such as electron accepting substances and dyes may be added in order to improve the sensitivity and inhibit the increase in residual potential and fatigue due to repeated use.

As the above-mentioned electron accepting substance, acid anhydrides such as succinic anhydride, maleic anhydride, phthalic anhydride and 4-chloronaphthalic anhydride, cyano compounds such as tetracyanoethylene and terephthalmalononitrile, aldehydes such as 4-nitrobenzaldehyde, anthraquinones such as anthraquinone and 1-nitroanthraquinone, polycyclic or heterocyclic nitro compounds such as 2,4,7-trinitrofluorene and 2,4,5,7-tetranitrofluorenone, or electron-attractive materials such as diphenoquinone compounds can be used. Also, compounds formed by polymerizing these electron-attractive materials can also be used.

As the above-mentioned dye, organic photoconductive compounds such as xanthene dyes, thiazine dyes, triphenylmethane dye, quinoline pigments or copper phthalocyanine can be used. These organic photoconductive compounds function as an optical sensitizing agent.

To the respective layers 12 and 13 of the photosensitive layer 14, an antioxidant or an ultraviolet absorber may be added. It is preferable to add the antioxidant or the ultraviolet absorber particularly to the charge transport layer 13, and thereby the stability of the coating solution can be enhanced in forming the respective layers by applying the coating solution. Furthermore, it is particularly preferable to add the antioxidant to the charge transport layer 13. By this addition of the antioxidant to the charge transport layer, the deterioration of the photosensitive layer due to gases such as ozone and nitrogen oxide can be decreased.

Accordingly, in accordance with the present invention, an electrophotographic photoreceptor, in which the electrophotographic photoreceptor further contains an antioxidant, is provided.

Examples of the above-mentioned antioxidant include phenolic compounds, hydrochinone compounds, tocopherol compounds and amine compounds. Among these compounds, hindered phenol derivatives or hindered amine derivatives, or mixtures thereof are suitably employed.

The total amount of these antioxidants to be used is preferably 0.1 parts by weight or more and 50 parts by weight or less per 100 parts by weight of the charge transport substance. When the total amount of these antioxidants to be used with respect to 100 parts by weight of the charge transport substance is less than 0.1 parts by weight, an adequate effect of improving the stability of the coating solution and improving the durability of the photoreceptor cannot be achieved, and when the total amount of these antioxidants is more than 50 parts by weight, this has an adverse effect on photoreceptor properties.

Therefore, as a favorable range of the usage of the antioxidant, a range of 0.1 parts by weight or more and 50 parts by weight or less with respect to 100 parts by weight of the charge transport substance was selected.

### Second Embodiment

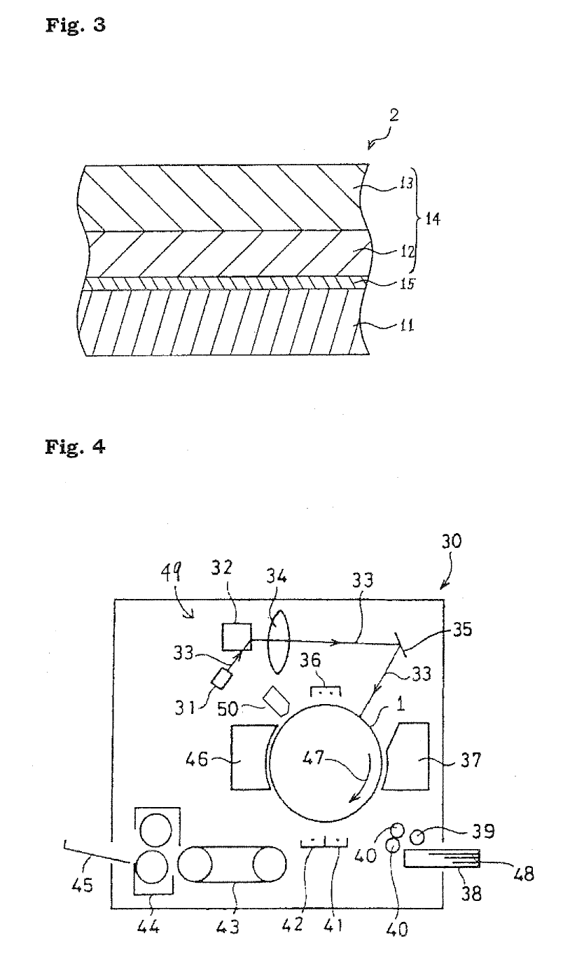

FIG. 3 is a partial sectional view showing schematically a constitution of an electrophotographic photoreceptor 2 of a second embodiment of the present invention. The electrophotographic photoreceptor 2 of the present embodiment is similar to the electrophotographic photoreceptor 1 of the first embodiment, and like reference characters designate like or corresponding parts, and description thereof will be omitted.

A remarkable point in the electrophotographic photoreceptor 2 is that an intermediate layer 15 is provided between the conductive substrate 11 and the photosensitive layer 14.

When the intermediate layer 15 is not provided between the conductive substrate 11 and the photosensitive layer 14, charge is injected from the conductive substrate 11 into the photosensitive layer 14, and a charging property of the photosensitive layer 14 is deteriorated, and surface charges other than those in an area to be erased by exposure are decreased, and therefore defects such as fog may occur in images. Particularly, when the image is formed by use of a reversal development process, since toner adheres to an area where surface charges are reduced by exposure to form a toner image, the fog of image referred to as a black spot, in which toner adheres to a white background to form minute black points, may occur and significant deterioration of image quality may occur if surface charges are reduced by factors other than exposure.

### (Intermediate Layer)

That is, when the intermediate layer 15 is not provided between the conductive substrate 11 and the photosensitive layer 14, a charging property in a minute region is deteriorated resulting from the defect of the conductive substrate 11 or the photosensitive layer 14, and the fog of image such as a black spot may occur and significant image defect may occur.

In the electrophotographic photoreceptor 2 of the present embodiment, since the intermediate layer 15 is provided between the conductive substrate 11 and the photosensitive layer 14 as described above, the charge injection from the conductive substrate 11 into the photosensitive layer 14 can be prevented. Therefore, the deterioration of the charging property of the photosensitive layer 14 can be prevented, decrease in surface charges other than those in an area to be erased by exposure can be inhibited, and the occurrence of defects such as fog in images can be prevented.

Further, by providing the intermediate layer 15, it is possible to cover the bumps and dips of the surface of the conductive substrate 11 to attain a uniform surface, and therefore a film forming property of the photosensitive layer 14 can be enhanced. Further, it is possible to inhibit peeling of the photosensitive layer 14 from the conductive substrate 11 and improve the adhesion between the conductive substrate 11 and the photosensitive layer 14.

For this intermediate layer 15, a resin layer made of various resin materials or an anodized aluminum layer is used.

Examples of the resin materials composing the above-mentioned resin layer include resins such as a polyethylene resin, a polypropylene resin, a polystyrene resin, an acrylic resin, a vinyl chloride resin, a vinyl acetate resin, a polyurethane resin, an epoxy resin, a polyester resin, a melamine resin, a silicone resin, a polyvinyl butyral resin, a polyvinylpyrrolidone resin, a polyacrylamide resin and a polyamide resin, and copolymer resins containing two or more of repeat units composing these resins. Further, casein, gelatin, polyvinyl alcohol, cellulose, nitrocellulose and ethylcellulose are also exemplified.

It is preferable to use a polyamide resin among these resins, particularly preferably to use an alcohol-soluble nylon resin.

Examples of a preferable alcohol-soluble nylon resin include the so-called copolymerized nylons formed by copolymerizing 6-nylon, 6,6-nylon, 6,10-nylon, 11-nylon, 2-nylon and 12-nylon, and resins formed by chemically modifying nylon such as N-alkoxymethyl modified nylon and N-alkoxyethyl modified nylon.

Further, the intermediate layer 15 may contains particles such as metal oxide particles. By including the metal oxide particles in the intermediate layer 15, the volume resistivity of the intermediate layer 15 can be controlled to enhance an effect of preventing the charge injection from the conductive substrate 11 into the photosensitive layer 14, and electric properties of the photoreceptor can be maintained under various environments.

Examples of the above-mentioned metal oxide particles include particles of metals such as titanium oxide, aluminum oxide, aluminum hydroxide and tin oxide.

In addition, for example, the above-mentioned resin is dissolved or dispersed in an appropriate solvent to prepare a coating solution for an intermediate layer, and the intermediate layer 15 is formed by applying this coating solution onto the surface of the conductive substrate 11. When the above-mentioned particles such as metal oxide particles are included in the intermediate layer 15, these metal oxide particles are dispersed in a resin solution obtained by dissolving, for example, the resin in an appropriate solvent to prepare a coating solution for an intermediate layer, and the intermediate layer 15 can be formed by applying this coating solution onto the surface of the conductive substrate 11.

For the solvent of the coating solution for an intermediate layer, water or various organic solvents, or a mixed solvent thereof are used. For example, water, a single solvent of methanol, ethanol or butanol, or a mixed solvent of water and alcohols, two or more species of alcohols, acetone or dioxolane and alcohols, and a halogen organic solvent such as dichloroethane, chloroform or trichloroethane and alcohols is used. Among these solvents, non-halogen organic solvents are suitably used in consideration of earth's environment.

As a method of dispersing the particle in the resin solution, a common method, in which a ball mill, a sand mill, an Attritor, a vibrating mill, an ultrasonic dispersion machine or a paint shaker is used, can be used.

In the coating solution for an intermediate layer, a ratio C/D between a total weight C of the resin and the metal oxide and a weight D of the solvent used in the coating solution for an intermediate layer is preferably 1/99 to 40/60, and more preferably 2/98 to 30/70. Further, a ratio E/F between a weight E of the resin and a weight F of the metal oxide is preferably 90/10 to 1/99, and more preferably 70/30 to 5/95.

Examples of a method of applying the coating solution for an intermediate layer include a spray coating method, a bar coating method, a roller coating method, a blade coating method, a ring coating method and a dip coating method. Among these application methods, particularly, the dip coating method is often used in forming the intermediate layer 15 since it is relatively simple and superior in point of productivity and cost as described above.

A film thickness of the intermediate layer 15 is preferably 0.01 μm or more and 20 μm or less, and more preferably 0.05 μm or more and 10 μm or less.

When the film thickness of the intermediate layer 15 is less than 0.01 μm, the intermediate layer 15 does not substantially function as an intermediate layer, and it cannot cover the bumps and dips of the conductive substrate 11 to attain a uniform surface texture, and cannot prevent the charge injection from the conductive substrate 11 into the photosensitive layer 14, leading to the occurrence of the deterioration of the charging property of the photosensitive layer 14.

Further, it is not preferable to use the intermediate layer 15 having a film thickness more than 20 μm since in the case of forming the intermediate layer 15 by dip coating method, the formation of the intermediate layer 15 becomes difficult and the photosensitive layer 14 cannot be uniformly formed on the intermediate layer 15, and therefore the sensitivity of the photoreceptor 1 is reduced.

Therefore, as a favorable range of the film thickness of the intermediate layer 15, a range of 0.01 μm or more and 20 μm or less is selected.

A method of producing a photoreceptor of the present invention preferably comprises steps of drying the respective layers such as the charge generation layer 12, the charge transport layer 13, the intermediate layer 15 and the like.

As a drying temperature of the photoreceptor, about 50° C. to about 140° C. is appropriate. Particularly, a range from about 80° C. to about 130° C. is preferable. When the drying temperature of the photoreceptor is less than about 50° C., a drying time is lengthened, and when the drying temperature is more than about 140° C., electrical properties is deteriorated in repeated use, and images obtained by use of the photoreceptor is also deteriorated

### Third Embodiment

FIG. 4 is a layout side view showing schematically a constitution of an image forming apparatus 30 of the third embodiment of the present invention. The image forming apparatus 30 shown in FIG. 4 is a laser printer having the photoreceptor 1 of the first embodiment of the present invention. Hereinafter, the constitution and image forming actions of the laser printer 30 will be described referring to FIG. 4.

A laser printer 30 illustrated in FIG. 4 is an exemplification of the present invention, and an image forming apparatus of the present invention is not limited to the following description.

The laser printer 30 being an image forming apparatus has a constitution including the photoreceptor 1, a semiconductor laser 31, a rotational polygon mirror 32, an imaging lens 34, a mirror 35, a corona charger 36 being charging means, a developing device 37 being a development unit, a transfer paper cassette 38, a feed roller 39, a resist roller 40, a transfer charger 41 being transfer means, a separation charger 42, a transfer belt 43, a fusing device 44, an output tray 45, and a cleaner 46 being a cleaning unit.

In addition, the semiconductor laser 31, rotational polygon mirror 32, imaging lens 34 and mirror 35 constitute an exposure unit 49.

The photoreceptor 1 is mounted on the laser printer 30 so as to rotate in the direction of an arrow 47 with a driving unit not shown. A laser beam 33 outputted from the semiconductor laser 31 is scanned repeatedly in the direction of the length (main scanning direction) relative to the surface of the photoreceptor 1 by the rotational polygon mirror 32. The imaging lens 34 has an f-θ characteristic and the laser beam 33 is reflected by the mirror 35 and forms an image on the surface of the photoreceptor and exposes the image. An electrostatic latent image corresponding to image information is formed on the surface of the photoreceptor 1 by scanning the laser beam 33 as described above to form an image while rotating the photoreceptor 1.

The corona charger 36, the developing device 37, the transfer charger 41, the separation charger 42 and the cleaner 46 are provided in this order from upstream of a rotational direction, shown by the arrow 47, of the photoreceptor 1 toward downstream.

Further, the corona charger 36 is provided upstream of the image formation point of the laser beam 33 in a rotational direction of the photoreceptor 1 to charge the surface of the photoreceptor 1 uniformly. Therefore, since the laser beam 33 exposes the surface of the photoreceptor 1 uniformly charged, a difference between a charge amount of a site exposed by the laser beam 33 and a charge amount of a site not exposed arises to form the electrostatic latent image.

The developing device 37 is provided downstream of the image formation point of the laser beam 33 in a rotational direction of the photoreceptor 1 and supplies toner to the electrostatic latent image formed on the surface of the photoreceptor 1 to develop the electrostatic latent image as a toner image. Transfer paper 48 carried in the transfer paper cassette 38 is taken out sheet by sheet by the feed roller 39 and fed to the transfer charger 41 in synchronization with the exposure to the photoreceptor 1 by the resist roller 40. The toner image is transferred to the transfer paper 48 by the transfer charger 41. The separation charger 42 located in the vicinity of the transfer charger 41 diselectrifies the transfer paper to which the toner image is transferred to separate the transfer paper from the photoreceptor 1.

The transfer paper 48 separated from the photoreceptor 1 is transferred to the fusing device 44 by the transfer belt 43, and the toner image is fused with the fusing device 44. The transfer paper 48 in which the image is thus formed is discharge toward the output tray 45. In addition, after the transfer paper 48 is separated by the separation charger 42, in the photoreceptor 1 keeping on rotating, foreign substances, such as toner and paper powder, remaining on the surface of the photoreceptor 1 is cleaned by the cleaner 46. The photoreceptor 1, the surface of which is cleaned by the cleaner 46, is diselectrified by a diselectrifying lamp, not shown, provided together with the cleaner 46, and thereafter it is further rotated to repeat the sequential image formation operations beginning with the charging of the photoreceptor 1.

Therefore, in accordance with the present invention, an image forming apparatus, characterized by having the electrophotographic photoreceptor, charging means, an exposure unit, a development unit and transfer means, is provided.

### Fourth Embodiment

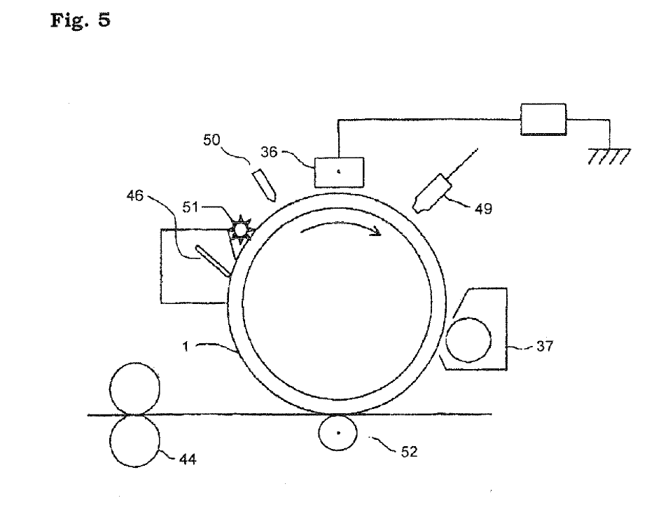

FIG. 5 shows a schematic constitution of an image forming apparatus of a fourth embodiment of the present invention.

The image forming apparatus shown includes the electrophotographic photoreceptor 1, the charger 36, the exposure unit 49, the developing device 37, a transfer device 52, the fusing device 44, the cleaner 46, a lubricant applying device 51 and a diselectrifying device 50. The charger 36, the exposure unit 49, the developing device 37, the transfer device 52, the cleaner 46, the lubricant applying device 51 and a diselectrifying device 50 are provided in this order from upstream of the rotational direction, shown by the arrow, of the photoreceptor 1 toward downstream around the photoreceptor 1.

Hereinafter, the fourth embodiment of the present invention will be described in detail.

### [Charger]

The charger 36 is the charging means to positively or negatively charge the peripheral surface of the photoreceptor 1 to a prescribed potential, and it may be a noncontact electrification unit (for example, a scorotron charger) such as a corona discharger, or may be a contact charging unit such as a charging roller. In the case of the latter charging roller, high printing durability is required of the surface of the photoreceptor, but the photoreceptor can be used without problems because of the improved durability of the photoreceptor in the image forming apparatus of the present invention.

### [Exposure Unit]

The exposure unit 49 is an exposure unit which can irradiate light in accordance with image information to the peripheral surface of the photoreceptor 1, for example, by scanning the photoreceptor 1 in a direction of a rotational axis thereof. The exposure unit includes, for example, the semiconductor laser as a light source.

### [Developing Device]

The developing device 37 is a development unit which develops the electrostatic latent image formed on the surface of the photoreceptor 1 with a developer (for example, toner) to form a toner image which is a visible image, and provided opposite to the photoreceptor 1. The developing device 37 includes, for example, a developing roller to supply toner to the peripheral surface of the photoreceptor 1, and a casing which supports the developing roller rotatably about a rotation axis parallel to the rotation axis of the photoreceptor 1 and holds a developer containing toner in its internal space.

### [Transfer Device]

The transfer device 52 is transfer means to transfer the toner image on the peripheral surface of the photoreceptor 1 onto transfer paper which is a recording medium supplied between the photoreceptor 1 and the transfer device 52 by the transfer means not shown. The transfer device 52 includes, for example, the charging means such as a corona discharger and is a noncontact transfer unit to transfer the toner image onto transfer paper by providing the transfer paper with charges opposed to that of the toner.

### [Fusing Device]

The fusing device 44 is a fusing unit to fuse the transferred image. The fusing device 44 includes, for example, a heating roller having a heating unit not shown and a pressing roller which is provided opposed to the heating roller and is pressed by the heating roller to form an abutting section.

### [Cleaner]

The cleaner 46 is a cleaning unit to remove and recover residual toner remaining on the peripheral surface of the photoreceptor 1 after the transfer of toner images. The cleaner 46 includes, for example, a cleaning blade, which is pressed against the peripheral surface of the photoreceptor 1 to cause the toner remaining on the peripheral surface to peel off, and a recovery casing which receives the toner peeled off by the cleaning blade.

### [Lubricant Applying Device]

The lubricant applying device 51 is a unit which provides the surface of the photoreceptor with a lubricant by applying the lubricant onto the peripheral surface of the photoreceptor 1. This lubricant applying device 51 is preferably placed so as to be able to abut against the photoreceptor 1 directly behind the cleaner 46. There are various forms such as a sponge form, a honeycomb structure made of a soft material and a fiber bundle for a contact portion of the application of the lubricant applying device, and a lubricant is kneaded into these member to be formed.

Examples of the lubricant material include alkaline metallic soap such as fatty acid salts and fluororesins such as polyethylene terephthalate and polyvinylidene fluoride, but zinc stearate and polyethylene terephthalate are particularly preferable in order to reduce a coefficient of friction better.

A particle diameter of the lubricant is preferably 10 to 300 nm.

It is proper that a film thickness of the lubricant to be applied is 10 to 300 nm. The reason for this is that when the film thickness falls within this range, required lubricating effect can be achieved and an effect on images (for example, the deterioration of image density or image deletion) is less.

### [Diselectrifying Device]

The diselectrifying device 50 is a unit to eliminate the charge remaining on the peripheral surface of the photoreceptor 1. The diselectrifying device 50 is, for example, a diselectrifying lamp.

Image formation operations by the above-mentioned image forming apparatus can be performed as follows.

When the photoreceptor 1 is rotationally driven by a driving unit not shown, first, the surface of the photoreceptor 1 is uniformly positively or negatively charged to a prescribed potential by the charger 36. Next, light in accordance with image information from an exposure unit is irradiated to the surface of the photoreceptor 1 from an exposure unit 49. Surface charges are removed by this exposure, and electrostatic latent images are formed on the surface of the photoreceptor 1 in a pattern according to the image information.

Subsequently, toner is supplied from the developing device 37 to the surface of the photoreceptor 1, and the electrostatic latent image on the surface of the photoreceptor 1 is developed to form a toner image.

The toner image is transferred onto paper supplied by the transfer device 52. The image transferred onto paper becomes a hardened image by heat fusing with the fusing device 44.

Thus, recording paper in which a printing process is completed and images are formed is discharged out of the image forming apparatus by a transferring unit not shown.

On the other hand, residual toner remaining on the photoreceptor 1 after the transfer of toner images by the transfer device 52 is peeled off from the photoreceptor 1 and recovered by the cleaner 46. Next, the lubricant is applied onto the surface of the photoreceptor 1 by the lubricant applying device 51. Thereafter, the charge remaining on the photoreceptor 1 is eliminated by the diselectrifying device 50.

Thereafter, the photoreceptor 1 is further rotationally driven to repeat the sequential operations beginning with the charging of the photoreceptor 1. Thus, images are sequentially formed.

In these sequential image formation operations, timing of the operation is controlled by a control section not shown.

Since the image forming apparatus of the present invention includes a photoreceptor which is superior in printing durability and durability without decreasing sensitivity, it is possible to form images of high quality without image deletion and filming for a long time.

Therefore, in accordance with the present invention, an image forming apparatus, characterized by having the electrophotographic photoreceptor, the charging means, an exposure unit, a development unit, the transfer means and a diselectrifying unit, and in addition a lubricant applying device, is provided.

The image forming apparatus of the present invention is not limited to a constitution of the image forming apparatus shown in FIGS. 4 and 5, and it can be various printers, copying machines, facsimile and complex machines, utilizing an electrophotographic process, regardless of whether monochrome or color as long as it is a device to which the above-mentioned photoreceptor can be applied.

In addition, the image forming apparatus of the present invention is not limited to the embodiments described above, and various variations and modifications may be made without departing from the sprit of the present invention, and other embodiments will be readily understood from the description of the present specification and drawing.

### EXAMPLES

Hereinafter, the present invention will be described in more detail by way of examples, but the present invention is not limited to the following description.

The respective components used in the present examples are specifically as follows.

### [Titanium Oxide]

Trade name: TTO-MI-1, produced by ISHIHARA SANGYO KAISHA, Ltd.
Dendritic rutile titanium oxide (titanium component 85%) surface treated with Al₂O₃ and ZrO₂

### [Alcohol-Soluble Nylon Resin]

Trade name: CM-8000, produced by Toray Industries, Inc.

### [Butyral Resin]

Trade name: S-LEC BX-1, produced by Sekisui Chemica Co., Ltd.

### [Polycarbonate Resin]

Trade name: GH-503, produced by Idemitsu Kosan Co., Ltd.

Trade name: TS 2040, produced by Teijin Chemicals Ltd.

### [Antioxidant]

Trade name: SUMILIZER BHT, produced by Sumitomo Chemical Co., Ltd.

Trade name: Irganox 1010, produced by Ciba Specialty Chemicals K.K.

### [Silica]

Trade name: TS-610, produced by Cabot Specialty Chemicals Inc.
Average particle diameter 17 nm

Trade name: SO-E1, produced by Admatechs Corporation Limited
Average particle diameter 0.25 μm

Trade name: SO-E5, produced by Admatechs Corporation Limited
Average particle diameter 1.5 μm

### [Alumina]

Trade name: NanoTek Al₂O₃, produced by C.I. KASEI Co., Ltd.
Average particle diameter 31 nm

Trade name: SUMICORUNDUM AA-04, produced by Sumitomo Chemical Co., Ltd.
Average particle diameter 0.4 μm

### [Zinc Stearate]

Trade name: SZ 2000

### [Polytetrafluoroethylene]

Trade name: LUBLON L-2, produced by DAIKIN INDUSTRIES, Ltd.

Hereinafter, these components will be described by their trade name.

First, a photoreceptor produced for Examples and Comparative Examples, in which a photosensitive layer is formed on an aluminum conductive substrate having a diameter of 30 mm and a length of 340 mm under various conditions, will be described.

### Example 1

3 g of titanium oxide (TTO-MI-1), 3 g of an alcohol-soluble nylon resin (CM-8000), 60 g of methanol and 40 g of 1,3-dioxolane were dispersed for 10 hours with a paint shaker to prepare a coating solution for an intermediate layer. Using the prepared coating solution for an intermediate layer, a film was formed on an aluminum cylindrical support having a diameter of 30 mm and a length of 340 mm so as to be 0.9 μm in a film thickness by a dip coating method, and the coating solution was dried naturally.

Next, 10 g of a butyral resin (S-LEC BM-1), 1400 g of 1,3-dioxolane and 15 g of titanyl phthalocyanine (B) expressed by the following structural formula (B):

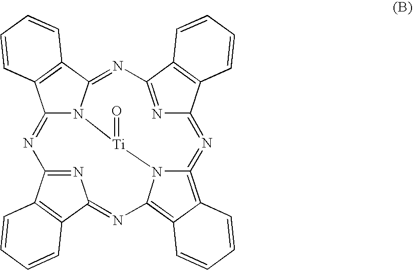

were dispersed for 72 hours with a ball mill to prepare a coating solution for a charge generation layer. By use of this coating solution, a charge generation layer was formed on the aluminum cylindrical support, on which the intermediate layer was provided, so as to be 0.2 μm in a film thickness by a dip coating method, and the coating solution was dried naturally.

Next, 1.8 g of a polycarbonate resin (TS 2040) and 1.8 g of silica (TS-610, average particle diameter: 17 nm) were mixed in 32.4 g of tetrahydrofuran, and the resulting mixture was dispersed for 5 hours with a ball mill using a ZrO₂ bead (3 mm in diameter) as a media to prepare a primarily dispersed coating solution for a charge transport layer. In addition, in this stage, it was confirmed that filler particles are evenly dispersed and a dispersion state corresponding to a primary particle diameter of the silica is retained using a particle size distribution measuring device: UPA-150 (manufactured by NIKKISO Co., Ltd.).

Next, as a charge transport substance, 100 g of a butadiene compound expressed by the following structural formula (2):

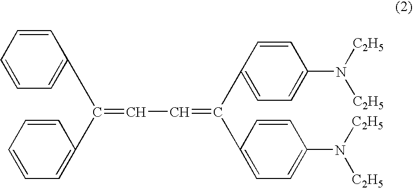

138.2 g of a polycarbonate resin (TS 2040) and 5 g of an antioxidant (SUMILIZER BHT) were mixed and dissolved in 984 g of tetrahydrofuran to form a solution. 3.6 g of the primarily dispersed coating solution for a charge transport layer was mixed in this solution, and the resulting mixture was stirred for 15 hours to prepare a secondary dispersed coating solution for a charge transport layer. This coating solution was applied onto the charge generation layer by a dip coating method, and dried at 130° C. for 1 hour to form a charge transport layer having a layer thickness of 28 μm to produce a photoreceptor of Example 1.

### Example 2

As a coating solution for a charge transport layer, 1.25 g of a polycarbonate resin (TS 2040) and 1.25 g of silica (TS-610, average particle diameter: 17 nm) were mixed in 22.5 g of tetrahydrofuran, and the resulting mixture was dispersed for 5 hours with a ball mill as with Example 1 to prepare a primarily dispersed coating solution for a charge transport layer. Next, as a charge transport substance, 100 g of a butadiene compound expressed by the above-mentioned structural formula (2), 138.75 g of a polycarbonate resin (TS 2040) and 5 g of an antioxidant (SUMILIZER BHT) were mixed and dissolved in 984 g of tetrahydrofuran. A photoreceptor of Example 2 was produced in the same manner as in Example 1 except for the above operations.

### Example 3

As a coating solution for a charge transport layer, 3.1 g of a polycarbonate resin (TS 2040) and 3.1 g of silica (TS-610, average particle diameter: 17 nm) were mixed in 55.8 g of tetrahydrofuran, and the resulting mixture was dispersed for 5 hours with a ball mill as with Example 1 to prepare a primarily dispersed coating solution for a charge transport layer. Next, as a charge transport substance, 100 g of a butadiene compound expressed by the above structural formula (2), 136.9 g of a polycarbonate resin (TS 2040) and 5 g of an antioxidant (SUMILIZER BHT) were mixed and dissolved in 992 g of tetrahydrofuran. A photoreceptor of Example 3 was produced in the same manner as in Example 1 except for the above operations.

### Example 4

As a coating solution for a charge transport layer, 4.65 g of a polycarbonate resin (TS 2040) and 4.65 g of silica (TS-610, average particle diameter: 17 nm) were mixed in 83.7 g of tetrahydrofuran, and the resulting mixture was dispersed for 5 hours with a ball mill as with Example 1 to prepare a primarily dispersed coating solution for a charge transport layer. Next, as a charge transport substance, 100 g of a butadiene compound expressed by the above structural formula (2), 135.35 g of a polycarbonate resin (TS 2040) and 5 g of an antioxidant (SUMILIZER BHT) were mixed and dissolved in 998 g of tetrahydrofuran. A photoreceptor of Example 4 was produced in the same manner as in Example 1 except for the above operations.

### Example 5

A photoreceptor of Example 5 was produced in the same manner as in Example 3 except for changing the filler particles to alumina (SUMICORUNDUM AA-04, average particle diameter: 400 nm) in preparing a coating solution for a charge transport layer.

### Example 6

A photoreceptor of Example 6 was produced in the same manner as in Example 3 except for changing the filler particles to silica (X-24-9163A, average particle diameter: 100 nm) in preparing a coating solution for a charge transport layer.

### Example 7

A photoreceptor of Example 7 was produced in the same manner as in Example 3 except for changing the filler particles to silica (SO-E5, average particle diameter: 1.5 μm) in preparing a coating solution for a charge transport layer.

### Example 8

A photoreceptor of Example 8 was produced in the same manner as in Example 3 except for changing the charge transport substance to 90 g of a triarylamine compound expressed by the following structural formula (3):

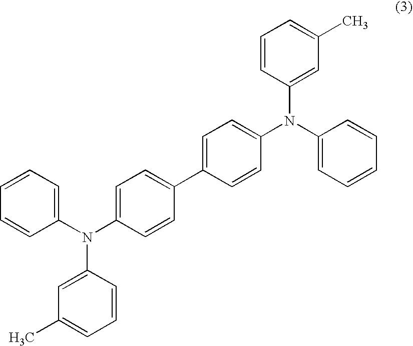

and 10 g of a butadiene compound expressed by the following structural formula (4):

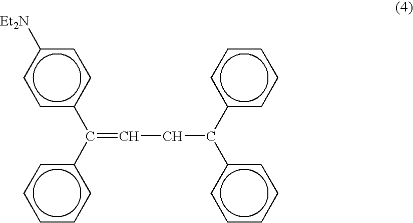

in preparing a coating solution for a charge transport layer.

### Example 9

A photoreceptor of Example 9 was produced in the same manner as in Example 3 except for using 100 g of a triarylamine compound expressed by the above structural formula (3) as a charge transport substance in preparing a coating solution for a charge transport layer.

### Example 10

A photoreceptor of Example 10 was produced in the same manner as in Example 3 except for using 100 g of a styryl compound, expressed by the following structural formula (5):

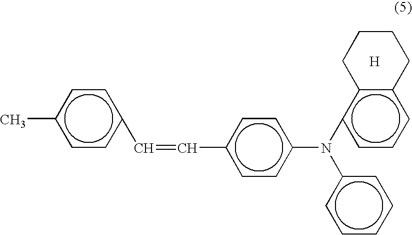

as a charge transport substance in preparing a coating solution for a charge transport layer.

### Example 11

A photoreceptor of Example 11 was produced in the same manner as in Example 3 except for not adding an antioxidant (SUMILIZER BHT) as a coating solution for a charge transport layer.

### Comparative Example 1

As a coating solution for a charge transport layer, 3.1 g of a polycarbonate resin (TS 2040) and 3.1 g of silica (TS-610, average particle diameter: 17 nm) were mixed in 55.8 g of tetrahydrofuran, and the resulting mixture was dispersed for 5 hours with a paint shaker to prepare a primarily dispersed coating solution for a charge transport layer. Thereafter, a particle size distribution was measured in the same manner as in Example 1, and consequently it was confirmed that coarse agglomerates extremely larger than a primary particle size were clearly formed. A photoreceptor of Comparative Example 1 was produced in the same manner as in Example 3 except for the above operations.

### Comparative Example 2

As a coating solution for a charge transport layer, 1.2 g of a polycarbonate resin (TS 2040) and 1.2 g of silica (TS-610, average particle diameter: 17 nm) were mixed in 21.6 g of tetrahydrofuran, and the resulting mixture was dispersed for 5 hours with a ball mill as with Example 1 to prepare a primarily dispersed coating solution for a charge transport layer. Next, as a charge transport substance, 100 g of a butadiene compound expressed by the above structural formula (2), 139.8 g of a polycarbonate resin (TS 2040) and 5 g of an antioxidant (SUMILIZER BHT) were mixed and dissolved in 980 g of tetrahydrofuran, and to the resulting a solution, 2.4 g of the primarily dispersed coating solution was added, and the resulting mixture was mixed and stirred for 15 hours to prepare a secondary dispersed coating solution for a charge transport layer. A photoreceptor of Comparative Example 2 was produced in the same manner as in Example 1 except for the above operations.

### Comparative Example 3

As a coating solution for a charge transport layer, 5.0 g of a polycarbonate resin (TS 2040) and 5.0 g of silica (TS-610) were mixed in 90 g of tetrahydrofuran, and the resulting mixture was dispersed for 5 hours with a ball mill to prepare a primarily dispersed coating solution for a charge transport layer. Next, as a charge transport substance, 100 g of a butadiene compound expressed by the above structural formula (2), 135.0 g of a polycarbonate resin (TS 2040) and 5 g of an antioxidant (SUMILIZER BHT) were mixed and dissolved in 1005.6 g of tetrahydrofuran. A photoreceptor of Comparative Example 3 was produced in the same manner as in Example 1 except for the above operations.

### Comparative Example 4

As a charge transport substance, 100 g of a butadiene compound expressed by the above structural formula (2), 140 g of a polycarbonate resin (TS 2040) and 5 g of an antioxidant (SUMILIZER BHT) were mixed and dissolved in 980 g of tetrahydrofuran. A photoreceptor of Comparative Example 4 was produced in the same manner as in Example 1 except for the above operations.

TABLE 1
Table 1 Content of photoreceptor charge transport layer

| | Filler | | | | | | Dispersion | | | |
|---|---|---|---|---|---|---|---|---|---|---|
| | | | Primary | | | | state of filler | | | |
| | Kinds | | particle | | | | (primary | | | |
| | of filler | Composition | diameter | Density | Rf | Content | solution) | CTM | Resin | Antioxidant |
| Example 1 | TS-610 | Silica | 17 nm | 2.0 | 1.00 × 10⁻³ | 0.04% | ◯ | Chemical formula (2) | TS2040 | BHT5% |
| Example 2 | ↑ | ↑ | ↑ | ↑ | 6.72 × 10⁻³ | 0.50% | ↑ | ↑ | ↑ | ↑ |
| Example 3 | ↑ | ↑ | ↑ | ↑ | 1.72 × 10⁻² | 1.25% | ↑ | ↑ | ↑ | ↑ |
| Example 4 | ↑ | ↑ | ↑ | ↑ | 2.50 × 10⁻² | 1.25% | ↑ | ↑ | ↑ | ↑ |
| Example 5 | AA-04 | Alumina | 0.4 μm | 3.9 | 1.69 × 10⁻² | 1.25% | ↑ | ↑ | ↑ | ↑ |
| Example 6 | X-24 | Silica | 100 nm | 2.0 | 1.72 × 10⁻² | 1.25% | ↑ | ↑ | ↑ | ↑ |
| Example 7 | SO-E5 | ↑ | 1.5 μm | ↑ | ↑ | 1.25% | ↑ | ↑ | ↑ | ↑ |
| Example 8 | TS-610 | ↑ | 17 nm | ↑ | ↑ | 1.25% | ↑ | Chemical formula (3)/ | ↑ | ↑ |
| | | | | | | | | chemical formula (4) | | |
| Example 9 | ↑ | ↑ | ↑ | ↑ | ↑ | 1.25% | ↑ | Chemical formula (3) | ↑ | ↑ |
| Example 10 | ↑ | ↑ | ↑ | ↑ | ↑ | 1.25% | ↑ | Chemical formula (5) | ↑ | ↑ |
| Example 11 | ↑ | ↑ | ↑ | ↑ | ↑ | 1.25% | ↑ | Chemical formula (2) | ↑ | None |
| Comparative | ↑ | ↑ | ↑ | ↑ | — | 1.250% | X | ↑ | ↑ | BHT 5% |
| Example 1 | | | | | | | | | | |
| Comparative | ↑ | ↑ | ↑ | ↑ | 6.72 × 10⁻⁴ | 0.050% | ◯ | ↑ | ↑ | ↑ |
| Example 2 | | | | | | | | | | |
| Comparative | ↑ | ↑ | ↑ | ↑ | 2.75 × 10⁻² | 2.00% | ↑ | ↑ | ↑ | ↑ |
| Example 3 | | | | | | | | | | |
| Comparative | | | | | | | | ↑ | ↑ | ↑ |
| Example 4 | | | | | | | | | | |

In this Table, Rf means a relative filler particle diameter to an average filler interparticle distance, defined by (df×b³)/(dm×a³), (here, “a” is an average filler interparticle distance (nm); “b” is an average diameter (nm) of filler particles; “df” is a density (g/cm³) of the filler particles; and “dm” is an average density (g/cm³) of a solid in the outermost surface layer).

The respective photoreceptors of Examples 1 to 11 and Comparative Examples 1 to 4 was loaded in a digital copying machine AR-450 (manufactured by Sharp Corporation) modified for a test, and evaluation tests of sensitivity, printing durability, and a degree of image deterioration were performed by forming 100000 sheets of images using an A4-sized chart of coverage rate 6%.

Methods of evaluating performance will be described below.

### [Evaluation of Electrical Properties]

A developing device was removed from the above-mentioned copying machine for a test, and a surface electrometer (Model 344 manufactured by TREK JAPAN Co., Ltd.) was place in a developing site instead. Using this copying machine, in environments of normal temperature of 25° C. and normal humidity of 50% in relative humidity (N and N: normal temperature and normal humidity), the surface potential of the photoreceptor in the case of not applying the exposure by laser light was adjusted to −650 V, and the surface potential of the photoreceptor in performing exposures (0.4 μJ/cm²) with laser light in this state is defined as an exposure potential VL (V).

A smaller absolute value of the exposure potential VL was rated as high sensitivity.

### <Rating Criteria>

O:|VL|<90(V)

Δ:90(V)≦|VL|<150(V)

×:150(V)≦|VL|

### [Printing Durability]

A pressure at which a cleaning blade of a cleaning device included in the above-mentioned modified machine of AR-450 abuts against a photoreceptor, the so-called cleaning blade pressure, was adjusted to 21 gf/cm (2.06×10⁻¹ N/cm) in terms of an initial line pressure.

In environments of N and N, images of A4-sized character test chart of coverage rate 6% were formed on 100000 sheets of recording paper for each photoreceptor to perform a printing durability test.

A film thickness, that is, a layer thickness of a photosensitive layer, was measured with a thin film thickness measuring device (trade name: F20-EXR, manufactured by Filmetrics Japan, Inc.) at the beginning of the printing durability test and after the image formation on 100000 sheets of recording paper, and an abrasion rate (film decreasing rate) per 100K rotations of a photoreceptor drum was determined from a difference between the film thickness at the beginning of the printing durability test and the film thickness after the image formation on 100000 sheets of recording paper. More abrasion rate was rated as bad printing durability.

### <Rating Criteria>

O:abrasion rate d<0.8 μm/100K rotations

Δ:0.8 μm/100K rotations≦abrasion rate d<1.0 μm/100K rotations

×:1.0 μm/100K rotations≦abrasion rate d

### [Rating of Image Deterioration}

In order to investigate a degree of image quality deterioration of the photoreceptor after the printing durability test, irregularities in a density at a half-tone image were evaluated. Rating criteria of irregularities in a density are as follows.

O: Irregularities in a density are not visually observed in a half-tone image. Good image.

Δ: Irregularities in a density are visually observed in a half-tone image. Good image. A practically problem-free level.

×: Irregularities in a density are visually observed in a half-tone image. Good image. A practically problematic level.

### [Overall Evaluation]

The overall evaluation is rated according to the following criteria based on rating results of the above-mentioned three items.

⊙: All three items are O

O: Three items are O or Δ

×: At least one item is ×

### [Results of Evaluation]

The results of evaluation are shown in Table 2.

### [Table 2]

TABLE 2
Results of evaluation of photoreceptor

| | Sensitivity VL | | | | | | |
|---|---|---|---|---|---|---|---|
| | (−V) | | | Film | | | |
| | | After | | thickness | | | |
| | | actually | | reduction | Rating of | | |
| | Initial | printing | | rate | film | Rating of | |
| | VL1 | VL2 | Evaluations of | μm/100K | thickness | image | Overall |
| | (−V) | (−V) | sensitivity/stability | rotations | reduction | deterioration | evaluation |
| Example 1 | 62 | 80 | ◯ | 0.70 | ◯ | ◯ | ⊙ |
| Example 2 | 65 | 82 | ◯ | 0.65 | ◯ | ◯ | ⊙ |
| Example 3 | 70 | 85 | ◯ | 0.54 | ◯ | ◯ | ⊙ |
| Example 4 | 75 | 89 | ◯ | 0.52 | ◯ | ◯ | ⊙ |
| Example 5 | 95 | 155 | Δ | 0.56 | ◯ | ◯ | ◯ |
| Example 6 | 85 | 100 | Δ | 0.58 | ◯ | ◯ | ◯ |
| Example 7 | 90 | 110 | Δ | 0.55 | ◯ | ◯ | ◯ |
| Example 8 | 75 | 91 | Δ | 0.70 | ◯ | ◯ | ◯ |
| Example 9 | 70 | 82 | ◯ | 0.60 | ◯ | Δ | ◯ |
| Example 10 | 76 | 100 | Δ | 0.68 | ◯ | Δ | ◯ |
| Example 11 | 64 | 81 | ◯ | 0.63 | ◯ | Δ | ◯ |
| Comparative | 61 | 200 | X | 0.60 | ◯ | ◯ | X |
| Example 1 | | | | | | | |
| Comparative | 61 | 79 | ◯ | 1.40 | X | ◯ | X |
| Example 2 | | | | | | | |
| Comparative | 68 | 150 | X | 0.40 | ◯ | X | X |
| Example 3 | | | | | | | |
| Comparative | 58 | 79 | ◯ | 2.00 | X | ◯ | X |
| Example 4 | | | | | | | |

In the electrophotographic photoreceptor in which the filler particles used in Examples 1 to 11 satisfy the equation (I) described in claim, an average drum film thickness reduction rate in actually printing 100000 sheets is 1 μm/100K rotations or less and good printing durability is exhibited.

Further, from comparison among Examples 3, 6 and 7, it is found that electrical properties are more stabilized in smaller particle diameters.

Furthermore, from a comparison between these and Example 5, it was confirmed that silica is slightly superior in electrical stability to alumina.

Further, in the photoreceptors containing a specific nitrogen compound, that is, a butadiene charge transport substance expressed by chemical formulas (2) or (4), shown in Examples 3 and 8, it was confirmed that irregularities in an image density does not occur even after actually printing 100000 sheets of images and more stable images are provided compared with the photoreceptors of Examples 9 and 10.

The reason for this is assumed that these butadiene charge transport substances provide resistance to gases such as O₃ and NOx generated in the vicinity of a charger at the time of actually printing.

Further, it also became apparent from the comparison between Example 3 and Example 11 that the above-mentioned resistance to gases is also improved by the addition of the antioxidant.

In Comparative Example in which the photoreceptors beyond the scope of the method of adding the filler particles of the present invention are used, it is apparent that significant deterioration of electrical stability (Comparative Example 1), significant deterioration of printing durability (Comparative Examples 2 and 4) or significant increase in an exposure potential after actually printing (Comparative Example 3) is exhibited, and an effectiveness of the present invention is shown.

### Example 12

3 g of titanium oxide (TTO-MI-1) and 3 g of an alcohol-soluble nylon resin (CM-8000) were added to a mixture solvent of 60 g of methyl alcohol and 40 g of 1,3-dioxolane, and the resulting mixture was dispersed for 10 hours with a paint shaker to prepare a coating solution for an intermediate layer. This coating solution was filled into a coating bath, and the aluminum conductive substrate was immersed in the coating solution, pulled up, and dried naturally to form an intermediate layer having a layer thickness of 0.9 μm.

10 g of a butyral resin (S-LEC BX-1), 15 g of titanyl phthalocyanine expressed by the structural formula (B) and 1400 g of 1,3-dioxolane were dispersed for 72 hours with a ball mill to prepare a coating solution for a charge generation layer. This coating solution was applied onto the intermediate layer by the same application method as in the intermediate layer, and dried naturally to form a charge generation layer having a layer thickness of 0.4 μm.

Next, 0.7 g of a polycarbonate resin (GH-503), 0.6 g of a polycarbonate resin (TS 2040) and 1.2 g of silica (TS-610) were mixed in 22 g of tetrahydrofuran, and the resulting mixture was dispersed for 5 hours with a ball mill to prepare a primarily dispersed coating solution for a charge transport layer.

Subsequently, as a charge transport substance, 100 g of a butadiene compound expressed by the structural formula (2), 76.3 g of a polycarbonate resin (GH-503), 62.4 g of a polycarbonate resin (TS 2040) and 5 g of an antioxidant (SUMILIZER BHT) were mixed and dissolved in 963 g of tetrahydrofuran to form a solution.

This solution was mixed with the primarily dispersed coating solution for a charge transport layer, and the resulting mixture was further dispersed for 1 hour with a ball mill to prepare a secondary dispersed coating solution for a charge transport layer. This coating solution was applied onto the charge generation layer by a dip coating method, and dried at 130° C. for 1 hour to form a charge transport layer having a layer thickness of 28 μm to produce a photoreceptor of Example 12. In the equation (I), if (df×b³)/(dm×a³)=Rf (defined as a relative filler particle diameter to an average filler interparticle distance), in this photoreceptor, Rf=6.72×10⁻³ (df: 2.0, b≈17, dm=1.3, a≈104).

The produced photoreceptor was loaded in a modified machine of AR-450M, in which a monochrome complex machine AR-450M (manufactured by Sharp Corporation) having a noncontact electrification process was modified in such a way that a function of providing a lubricant can be provided for the photoreceptor after blade cleaning, and zinc stearate (SZ 2000) was used as a lubricant to perform an evaluation test.

### Example 13

As a primarily dispersed coating solution for a charge transport layer, 2.2 g of a polycarbonate resin (GH-503), 1.7 g of a polycarbonate resin (TS 2040) and 3.7 g of silica (TS-610) were mixed in 66 g of tetrahydrofuran, and the resulting mixture was dispersed for 5 hours with a ball mill to prepare a primarily dispersed coating solution for a charge transport layer. Next, as a charge transport substance, 100 g of a butadiene compound expressed by the structural formula (2), 75.0 g of a polycarbonate resin (GH-503), 61.3 g of a polycarbonate resin (TS 2040) and 5 g of an antioxidant (SUMILIZER BHT) were mixed and dissolved in 929 g of tetrahydrofuran to form a solution. This solution was mixed with the primarily dispersed coating solution for a charge transport layer, and the resulting mixture was further dispersed for 1 hour with a ball mill to prepare a secondary dispersed coating solution for a charge transport layer. A photoreceptor was produced in the same manner as in Example 12 except for the above-mentioned operations, and the photoreceptor was evaluated. In this photoreceptor, Rf=2.03×10⁻² (df: 2.0, b≈17, dm=1.3, a≈72).

### Example 14

A photoreceptor was produced in the same manner as in Example 12 except for using polytetrafluoroethylene (LUBLON L-2) as a lubricant in loading an evaluation machine, and the photoreceptor was evaluated.

### Example 15

As a primarily dispersed coating solution for a charge transport layer, 0.8 g of a polycarbonate resin (GH-503), 0.7 g of a polycarbonate resin (TS 2040) and 1.5 g of silica (TS-610) were mixed in 27 g of tetrahydrofuran, and the resulting mixture was dispersed for 5 hours with a ball mill to prepare a primarily dispersed coating solution for a charge transport layer. Next, as a charge transport substance, 100 g of a butadiene compound expressed by the structural formula (2), 109.2 g of a polycarbonate resin (GH-503), 89.3 g of a polycarbonate resin (TS 2040) and 5 g of an antioxidant (SUMILIZER BHT) were mixed and dissolved in 1199 g of tetrahydrofuran to form a solution. This solution was mixed with the primarily dispersed coating solution for a charge transport layer, and the resulting mixture was further dispersed for 1 hour with a ball mill to prepare a secondary dispersed coating solution for a charge transport layer. A photoreceptor was produced in the same manner as in Example 12 except for the above-mentioned operations, and the photoreceptor was evaluated. In this photoreceptor, Rf=6.72×10⁻³ (df: 2.0, b≈17, dm=1.3, a≈104).

### Example 16

A photoreceptor was produced in the same manner as in Example 12 except for using an enamine compound, expressed by the following structural formula (6):

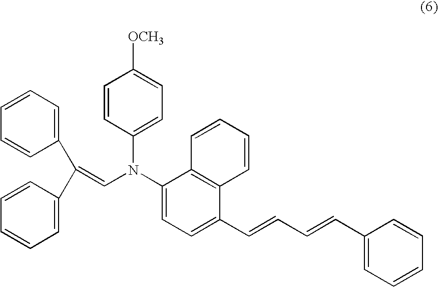

as a charge transport substance of a coating solution for a charge transport layer, and the obtained photoreceptor was evaluated. In this photoreceptor, Rf=6.72×10⁻³ (df: 2.0, b≈17, dm=1.3, a≈104).

### Example 17

A photoreceptor was produced in the same manner as in Example 12 except for mixing 0.7 g of a polycarbonate resin (GH-503), 0.6 g of a polycarbonate resin (TS 2040) and 1.2 g of alumina (NanoTek Al₂O₃) in 22 g of tetrahydrofuran as a primarily dispersed coating solution for a charge transport layer, and dispersing the resulting mixture for 5 hours with a ball mill to prepare a primarily dispersed coating solution for a charge transport layer, and the obtained photoreceptor was evaluated. In this photoreceptor, Rf=6.80×10⁻³ (df: 3.9, b≈31, dm=1.3, a≈236).

### Example 18

An intermediate layer and a charge generation layer were produced in the same manner as in Example 12. Next, as a charge transport substance, 100 g of a butadiene compound expressed by the structural formula (2), 77 g of a polycarbonate resin (GH-503), 63 g of a polycarbonate resin (TS 2040) and 5 g of an antioxidant (SUMILIZER BHT) were mixed and dissolved in 980 g of tetrahydrofuran to prepare a coating solution for a first charge transport layer. This coating solution was applied onto the charge generation layer by a dip coating method, and dried at 130° C. for 30 minutes to form a first charge transport layer having a layer thickness of 22 μm. Next, a secondary dispersed coating solution for a charge transport layer was formed in the same manner as in Example 12, and this coating solution was applied onto the first charge transport layer by a dip coating method, and dried at 130° C. for 1 hour to form a second charge transport layer having a layer thickness of 6 μm to produce a photoreceptor of Example 18, and on the photoreceptor, the same evaluation as in Example 12 was performed.

### Example 19

A photoreceptor was produced in the same manner as in Example 12 except for using a modified machine of AR-450 in which a function of providing a lubricant is eliminated as an evaluation machine, and the photoreceptor was evaluated.

### Comparative Example 5

As a primarily dispersed coating solution for a charge transport layer, 0.007 g of a polycarbonate resin (GH-503), 0.006 g of a polycarbonate resin (TS 2040) and 0.012 g of silica (TS-610) were mixed in 0.22 g of tetrahydrofuran, and the resulting mixture was dispersed for 5 hours with a ball mill to prepare a primarily dispersed coating solution for a charge transport layer. Next, as a charge transport substance, 100 g of a butadiene compound expressed by the structural formula (2), 77.0 g of a polycarbonate resin (GH-503), 63.0 g of a polycarbonate resin (TS 2040) and 5 g of an antioxidant (SUMILIZER BHT) were mixed and dissolved in 980 g of tetrahydrofuran to form a solution. This solution was mixed with the primarily dispersed coating solution for a charge transport layer, and the resulting mixture was further dispersed for 1 hour with a ball mill to prepare a secondary dispersed coating solution for a charge transport layer. A photoreceptor was produced in the same manner as in Example 12 except for the above-mentioned operations, and the photoreceptor was evaluated. In this photoreceptor, Rf=6.75×10⁻⁵ (df: 2.0, b≈17, dm=1.3, a≈482).

### Comparative Example 6

As a primarily dispersed coating solution for a charge transport layer, 4.0 g of a polycarbonate resin (GH-503), 3.3 g of a polycarbonate resin (TS 2040) and 7.4 g of silica (TS-610) were mixed in 132 g of tetrahydrofuran, and the resulting mixture was dispersed for 5 hours with a ball mill to prepare a primarily dispersed coating solution for a charge transport layer. Next, as a charge transport substance, 100 g of a butadiene compound expressed by the structural formula (2), 73.0 g of a polycarbonate resin (GH-503), 59.7 g of a polycarbonate resin (TS 2040) and 5 g of an antioxidant (SUMILIZER BHT) were mixed and dissolved in 877 g of tetrahydrofuran to form a solution. This solution was mixed with the primarily dispersed coating solution for a charge transport layer, and the resulting mixture was further dispersed for 1 hour with a ball mill to prepare a secondary dispersed coating solution for a charge transport layer. A photoreceptor was produced in the same manner as in Example 12 except for the above-mentioned operations, and the photoreceptor was evaluated. In this photoreceptor, Rf=4.08×10⁻² (df: 2.0, b≈17, dm=1.3, a≈57).

### Comparative Example 7

As a primarily dispersed coating solution for a charge transport layer, 6.7 g of a polycarbonate resin (GH-503), 5.5 g of a polycarbonate resin (TS 2040) and 12.3 g of silica (TS-610) were mixed in 221 g of tetrahydrofuran, and the resulting mixture was dispersed for 5 hours with a ball mill to prepare a primarily dispersed coating solution for a charge transport layer. Next, as a charge transport substance, 100 g of a butadiene compound expressed by the structural formula (2), 70.3 g of a polycarbonate resin (GH-503), 57.5 g of a polycarbonate resin (TS 2040) and 5 g of an antioxidant (SUMILIZER BHT) were mixed and dissolved in 809 g of tetrahydrofuran to form a solution. This solution was mixed with the primarily dispersed coating solution for a charge transport layer, and the resulting mixture was further dispersed for 1 hour with a ball mill to prepare a secondary dispersed coating solution for a charge transport layer. A photoreceptor was produced in the same manner as in Example 12 except for the above-mentioned operations, and the photoreceptor was evaluated. In this photoreceptor, Rf=6.83×10⁻² (df: 2.0, b≈17, dm=1.3, a≈48).

### Comparative Example 8

A photoreceptor was produced in the same manner as in Example 18 except for using the dispersed coating solution of Comparative Example 6 as a coating solution for a second charge transport layer, and the photoreceptor was evaluated.

### Comparative Example 9

A photoreceptor was produced in the same manner as in Example 19 except for using the dispersed coating solution of Comparative Example 6 as a dispersed coating solution for a charge transport layer, and the photoreceptor was evaluated.

### Comparative Example 10

An intermediate layer and a charge generation layer were produced in the same manner as in Example 12. Next, as a charge transport substance, 100 g of a butadiene compound expressed by the structural formula (2), 77 g of a polycarbonate resin (GH-503), 63 g of a polycarbonate resin (TS 2040) and 5 g of an antioxidant (SUMILIZER BHT) were mixed and dissolved in 980 g of tetrahydrofuran to prepare a coating solution for a charge transport layer. This coating solution was applied onto the charge generation layer by a dip coating method, and dried at 130° C. for 1 hour to form a charge transport layer having a layer thickness of 28 μm to produce a photoreceptor of Comparative Example 10, and on the photoreceptor, the same evaluation as in Example 12 was performed.

### Comparative Example 11

A photoreceptor was produced in the same manner as in Comparative Example 10 except for using a modified machine of AR-450, from which a function of providing a lubricant is removed, as an evaluation machine, and the photoreceptor was evaluated.

As for evaluations, the evaluation of sensitivity based on the measurement of a surface potential, and the evaluation of printing durability and image quality by actually forming images were performed. Methods of the evaluations will be described below.

### [Sensitivity]

In environments of normal temperature of 25° C. and normal humidity of 50% in relative humidity, a photoreceptor was loaded in a modified machine of AR-450M, and laser light with a wavelength of 780 nm was irradiated at 0.4 μJ/cm², and the sensitivity was rated from the surface potential after exposure.

### <Rating Criteria>

⊙:VL≦60

O:60<VL≦90

Δ:90<VL≦150

×:VL>150

### [Printing Durability]

Also in environments of normal temperature of 25° C. and normal humidity of 50% in relative humidity, images of A4-sized character test chart of coverage rate 6% were formed on 100000 sheets of recording paper for each photoreceptor to perform a printing durability test.

A layer thickness of a photosensitive layer was measured with a thin film thickness measuring device (trade name: F20-EXR, manufactured by Filmetrics Japan, Inc.) at the beginning of the printing durability test and after the image formation on 100000 sheets of recording paper (that is, after 100K rotations of a photoreceptor drum), and a film decreasing rate of the photoreceptor drum was determined from a difference between the layer thickness at the beginning of the printing durability test and the layer thickness after the image formation on 100000 sheets of recording paper. More film thickness reduction rate was rated as bad printing durability.

### <Rating Criteria>

⊙: Δd≦0.2 μm/100K rotations

O: 0.2 μm/100K rotations<Δd≦0.8 μm/100K rotations

Δ: 0.8 μm/100K rotations≦Δd<1.0 μm/100K rotations

×: Δd>1.0 μm/100K rotations

After the completion of an abrasion resistance test by formation of 100000 sheets of images in environments of normal temperature of 25° C. and normal humidity of 50% in relative humidity, a test machine was moved into environments of high temperature of 30° C. and high humidity of 85% in relative humidity, and images of A4-sized character test chart of coverage rate 6% were formed on 5000 sheets of recording paper and these images on the recording paper was left standing for the night, and thereafter, images were formed again and image quality was checked. Images in which particularly, image blurring or image deletion occurs are rated as an image defect. Here, an image not causing the image defect was denoted by “O”, an image causing image blurring and image deletion at a practically problematic level was denoted by “×”, and an image causing image blurring and image deletion at a practically problem-free level was denoted by “Δ”.

### [Overall Evaluation]

The overall evaluation is rated according to the following criteria based on rating results of the above-mentioned three items.

⊙: All three items are O

O: Three items are O or Δ

×: At least one item is ×

The results of evaluation are shown together in Table 3.

TABLE 3

| | | | | Film | | |
|---|---|---|---|---|---|---|
| | | | | thickness | | |
| | | | | reduction | | |
| | | VL surface | | rate | | |
| | | potential | Printing | (μm)/100K | Image | Overall |
| | Sensitivity | (−V) | durability | rotations | defect | evaluation |
| Example 12 | ⊙ | 56 | ◯ | 0.28 | ◯ | ⊙ |
| Example 13 | ◯ | 67 | ◯ | 0.22 | ◯ | ⊙ |
| Example 14 | ⊙ | 58 | ◯ | 0.30 | ◯ | ⊙ |
| Example 15 | ◯ | 89 | ◯ | 0.24 | ◯ | ⊙ |
| Example 16 | ◯ | 62 | ◯ | 0.34 | ◯ | ⊙ |
| Example 17 | ◯ | 90 | ◯ | 0.27 | ◯ | ⊙ |
| Example 18 | ⊙ | 49 | ◯ | 0.39 | ◯ | ⊙ |
| Example 19 | ⊙ | 54 | ◯ | 0.43 | ◯ | ⊙ |
| Comparative | ⊙ | 49 | X | 1.32 | ◯ | X |
| Example 5 | | | | | | |
| Comparative | Δ | 98 | ⊙ | 0.17 | X | X |
| Example 6 | | | | | | |
| Comparative | X | 175 | ⊙ | 0.16 | X | X |
| Example 7 | | | | | | |
| Comparative | ⊙ | 51 | ⊙ | 0.19 | X | X |
| Example 8 | | | | | | |
| Comparative | Δ | 91 | ◯ | 0.36 | X | X |
| Example 9 | | | | | | |
| Comparative | ⊙ | 47 | X | 0.98 | ◯ | X |
| Example 10 | | | | | | |
| Comparative | ⊙ | 45 | X | 1.67 | ◯ | X |
| Example 11 | | | | | | |

In the image forming apparatuses of Examples of the present invention, which include the photoreceptor having the outermost surface layer, satisfying the equation (I) and containing the filler particles having an average particle diameter of 100 nm or less, by providing the lubricant for the surface of the photoreceptor, an abrasion rate of the photoreceptor could be reduced while securing the sensitivity and further excellent printing durability was shown. In addition, images in environments of high temperature and high humidity was excellent.

On the other hand, in the image forming apparatuses of Comparative Examples 6 and 7, including the photoreceptor, in which with respect to Rf of the filler particles, a relative filler particle diameter to an average filler interparticle distance, Rf>2.5×10⁻², in the charge transport layer, the sensitivity decreased as Rf increased, and an image defect (image deletion) was produced though the printing durability was good.

In the image forming apparatuses including the photoreceptor in which the charge transport layer is composed of two layers and an upper layer thereof is a silica-containing layer, the image forming apparatuses (Comparative Example 8) including the photoreceptor having the outermost surface layer of Rf>2.5×10⁻² is inferior to the image forming apparatuses (Example 1) including the photoreceptor having the outermost surface layer satisfying the equation (I) in that an image defect was produced.

In the image forming apparatus in which the lubricant was not provided for the surface of the photoreceptor, in the case of Example 19 in which an Rf value in the charge transport layer satisfies the relationship of 1.0×10⁻³≦(df×b³)/(dm×a³)≦2.5×10⁻² (I), it can be confirmed from Table 2 that the printing durability is almost comparable to Comparative Example 9, and on the other hand the sensitivity is good and the occurrence of image defects is inhibited compared with Comparative Example 9 in which the Rf value has the relationship of Rf>2.5×10⁻².

In Example 17, aluminum was used in place of silica as the filler particles contained in the charge transport layer, the printing durability was good though the sensitivity was low when the particle having a smaller average particle diameter was used.

In Example 15 in which a ratio between the charge transport substance and the binding resin in the charge transport layer was 10/20, the sensitivity was reduced a little because the proportion of the charge transport substance was decreased.

Both the image forming apparatuses of Comparative Examples 10 and 11, which include the photoreceptors not containing particles in the charge transport layers, had good sensitivity without exhibiting the difference in sensitivity between image forming apparatuses, but the printing durability of these image forming apparatuses are largely different from each other depending on the presence or absence of the lubricant, and falls short of that in Examples.

What is claimed is:

1. An electrophotographic photoreceptor comprising at least a charge generation layer and a charge transport layer in this order on a conductive substrate, wherein an outermost surface layer of the electrophotographic photoreceptor contains filler particles and the filler particles in the layer satisfy the following equation (I):
1.0×10⁻³≦(df×b³)/(dm×a³)≦2.5×10⁻² (I),
wherein “a” is an average filler interparticle distance (nm), “b” is an average diameter (nm) of filler particles, “df” is a density (g/cm³) of the filler particles, and “dm” is an average density (g/cm³) of a solid in said outermost surface layer.

2. The electrophotographic photoreceptor according to claim 1, wherein said filler particles are made of silicon oxide.

3. The electrophotographic photoreceptor according to claim 1, wherein said filler particles have an average diameter of 100 nm or less.

4. The electrophotographic photoreceptor according to claim 1, wherein said charge transport layer contains, as a charge transport substance, an amine compound expressed by the following structural formula (1): 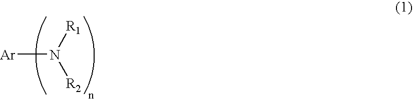
wherein R₁ and R₂ may be identical to or different from each other, and represent an alkyl group having 1 to 4 carbon atoms, or R₁ and R₂ may be combined with each other to form a heterocyclic group containing a nitrogen atom, n represents an integer of 1 to 4, and Ar represents an aromatic ring group having a substituted butadienyl group.

5. The electrophotographic photoreceptor according to claim 1, wherein said electrophotographic photoreceptor further contains an antioxidant.

6. An image forming apparatus, comprising the electrophotographic photoreceptor according to claim 1, charging means, an exposure unit, a development unit and transfer means.

7. The image forming apparatus according to claim 6, wherein a surface of said electrophotographic photoreceptor is provided with a lubricant.
